(19) United States
(12) Patent Application Publication
(10) Pub. No.: US 2009/0039672 A1
(43) Pub. Date: Feb. 12, 2009

(54) Glass run and manufacturing method thereof

(75) Inventors: Yoshihisa Kubo, Aichi-ken (JP); Atsushi Sumida, Aichi-Ken (JP); Tatsuhiko Nagata, Aichi-ken (JP); Soichiro Yamamoto, Aichi-ken (JP); Tamotsu Watanabe, Aichi-ken (JP); Masatoshi Hotta, Aichi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: TOYODA GOSEI CO., LTD., Nishikasugai-gun (JP)

(21) Appl. No.: 12/219,850

(22) Filed: Jul. 29, 2008

(30) Foreign Application Priority Data
Jul. 30, 2007 (JP) 2007-197165
Jul. 30, 2007 (JP) 2007-197166
Jul. 30, 2007 (JP) 2007-197167

(51) Int. Cl. B60J 10/04; B29C 45/14

(52) U.S. Cl. 296/146.2; 264/279

(57) ABSTRACT

A glass run includes a main body portion attached to a channel portion DC provided along an inner periphery of a door frame and having an approximately U-shape in section, formed of a base bottom portion and an exterior sidewall portion and an interior sidewall portion extending from the base bottom portion and an exterior seal lip and an interior seal lip extending from almost front ends of the exterior sidewall portion and the interior sidewall portion to an inside of the main body portion. Moreover, for the glass run, by molding, integrally formed is an entire longitudinal area having a sectional shape having the main body portion and the interior and exterior seal lips and provided with an upper side portion corresponding to an upper edge portion of a door glass and a front vertical side portion and a rear vertical side portion corresponding to a front edge portion and a rear edge portion of the door glass.

### BACKGROUND OF THE INVENTION

1. Field of the Invention

The present invention relates to a glass run and a manufacturing method thereof.

2. Related Art

Generally, a glass run is provided along the inner periphery of a door frame of an automobile. The glass run includes, when observed from a sectional direction thereof, a main body portion having an U-shape in section, formed of a base bottom portion and an interior sidewall portion and an exterior sidewall portion extending from the base bottom portion and also includes an interior seal lip and an exterior seal lip extending to the inside of the main body portion. The above-mentioned glass run is sealed such that the main body portion is attached to a mounting portion (channel portion) provided along the inner periphery of the door frame and marginal portions of the inner and outer surfaces of a door glass are sandwiched by the interior and exterior seal lips.

Moreover, the glass run is composed of extruded portions molded almost linearly and a molded portion that connects the extruded portions together in a state forming a predetermined angle therebetween, and is formed of, for example, a front vertical side portion, an upper side portion, and a rear vertical side portion along the shape of the door frame (see Japanese Patent Publication, JP 2006-8045A, for example)

Meanwhile, when the glass run is composed of extruded portions and a molded portion, a connection line between the extruded portion and molded portion may appear on the exterior and this may cause a degradation in external appearance quality. Moreover, the constituent material can also possibly differ between the extruded portion and molded portion, so that these have been greatly different in color and luster of the surfaces. Such a difference in color and luster may also cause a degradation in external appearance quality. Further, a step is easily formed at a boundary (connecting portion) between the extruded portion and molded portion, which may cause a decline in sealing performance. Moreover, when the sectional shape of the extruded portions is partially changed, a post processing is required for each of these.

In contrast thereto, it has also been proposed to mold a glass run as an interior structure and an exterior structure separately, and then incorporate both structures integrally (see U.S. Pat. No. 5,396,733, for example).

Adopting the technique of U.S. Pat. No. 5,396,733 allows avoiding such a situation that a difference in color and luster partially occurs in the longitudinal direction of a glass run and an unnecessary step is formed in the longitudinal direction.

However, in one described in U.S. Pat. No. 5,396,733, since an interior structure and an exterior structure are separately molded, at least two large molding devices or more are required, and this may cause an increase in cost. Moreover, not only required is an operation to assemble both structures, but a misalignment between both structures is also a concern, so that when both structures are not precisely assembled, this may cause a decline in sealing performance, a deterioration in a mounting state to a mounting portion, and the like.

Meanwhile, for an inner surface of the base bottom portion and door glass sliding surfaces of the seal lips which are parts, of the glass run, that slidingly contact the door glass, it is desirable, in order to improve slidability of the door glass, that a polyethylene (PE) tape is adhered or a sliding agent is applied to form a sliding layer.

However, when a sliding layer is formed, since a step of forming the sliding layer is required separately from the step of molding, this may cause not only an increase in man-hours but also a decline in manufacturing workability. Moreover, with regard to the glass run described in U.S. Pat. No. 5,396,733, when formation of sliding layers is intended at a stage where the exterior structure and the interior structure are apart, the number of times of adhesion or application may also be increased by that.

### SUMMARY OF THE INVENTION

The present invention has been made in view of the circumstances described above, and an object thereof is to provide a glass run that can improve external appearance quality and can improve manufacturing workability and suppress the manufacturing cost and a manufacturing method thereof.

Hereinafter, itemized descriptions will be given of respective means suitable for attaining the above-described object and the like. Also, operations and effects and the like unique to the corresponding means will be added according to necessity.

In the first aspect of the invention, there is provided a glass run comprising:
a main body portion attached to a mounting portion provided along an inner periphery of a door frame of a vehicle and having an approximately U-shape in section, the main body portion including a base bottom portion, an interior sidewall portion and an exterior sidewall portion extending from the base bottom portion; and
an interior seal lip and an exterior seal lip extending from almost front ends of the interior sidewall portion and the exterior sidewall portion to an inside of the main body portion,
wherein an entire longitudinal area is integrally formed by molding so as to be provided with an upper side portion corresponding to an upper edge portion of a door glass and a front vertical side portion and a rear vertical side portion corresponding to a front edge portion and a rear edge portion of the door glass, respectively,
an interval between the interior seal lip and the exterior seal lip at the time of molding is set to 1.5 mm or more and 3.0 mm or less, and
the main body portion and the interior and exterior seal lips are made of an olefinic thermoplastic elastomer.

According to the first aspect of the invention, the entire longitudinal area of the glass run is formed by molding. Therefore, as in, for example, the case where the glass run is composed of extruded bodies and a molded body, such a situation that a connection line between the extruded body and molded body appears on the exterior can be avoided. Moreover, such a situation that a difference in color and luster partially occurs in the longitudinal direction (circumferential direction) of the glass run can be avoided. As a result, an improvement in external appearance quality can be realized. Furthermore, such a possibility that an unnecessary step is formed in the longitudinal direction of the glass run can be avoided, so that an improvement in sealing performance can be realized.

Furthermore, since a molded body is higher in the degree of freedom of product design than an extruded body, even when, for example, a glass run is differentiated in the sectional shape at a specific part (when, for example, partially providing a protrusion or changing the length of the seal lips in the longitudinal direction), this can be easily molded by molding. Therefore, such a situation that a separate operation (post processing) is required for differentiating the sectional shape at a specific part can be avoided, so that an improvement in productivity can be realized.

Moreover, in comparison with, for example, when the glass run is formed by assembling a plurality of molded bodies, an improvement in manufacturing workability is realized since no assembling operation is required, and the cost can be reduced since one molding device is sufficient. Further, a possibility such that a misalignment and detachment of a plurality of molded bodies to compose a glass run causes a decline in sealing performance, a deterioration in a mounting state to a mounting portion, a decline in mounting workability, and the like can be prevented.

As described in the first aspect of the invention, providing the interval between the interior seal lip and the exterior seal lip as 1.5 mm or more allows securing the strength of a holding plate holding a mold (core) to mold the respective inner peripheral surfaces of the main body portion, the interior seal lip, and the exterior seal lip. Moreover, providing the interval between the interior seal lip and the exterior seal lip as 3.0 mm or less allows securing sealing performance to the inner and outer surfaces in the margin of the door glass that generally has a thickness of approximately 4.0 mm to 5.0 mm.

When the main body portion and seal lips are made of a rubber material such as EPDM (Ethylene Propylene Diene Monomer) rubber, the EPDM or the like has a relatively high viscosity, and when intending to fill this in every corner of the cavity of the molds, it becomes necessary to provide the injection pressure as a high pressure or it becomes necessary to increase the number of gates for injection. When the former construction is adopted, the EPDM or the like may intrude into abutting portion of a plurality of molds that form the cavity, and this may lead to burring. On the other hand, when the latter construction is adopted, this may cause complication of the mold structure. In contrast thereto, according to the invention, since the main body portion and seal lips are made of an olefinic thermoplastic elastomer (TPO) which is lower in viscosity than EPDM or the like, burring can be prevented and complication of the mold structure can be prevented to suppress an increase in the manufacturing cost. Moreover, as a result of forming the main body portion and seal lips of a TPO, a vulcanization step is not required, so that an improvement in productivity can be realized in this point as well.

In the upper side portion, a projection that is protruded upward from the base bottom portion may be partially provided.

As in the above feature, even when the projection that is protruded from the base bottom portion is provided, this can be integrally formed with the base bottom portion at the time of molding. Therefore, such a situation that a post processing is required due to provision of the projection, thus causing a decline in manufacturing workability can be avoided. Also, examples of the projection include a protrusion (buffering member) for buffering a shock when the door glass is shut, a protrusion, latched with a hole portion or a concave portion formed in the mounting portion, for controlling a deviation movement of the glass run in the longitudinal direction.

In the upper side portion, a glass guide that is protruded downward from a boundary between the exterior sidewall portion and the external seal lip may be provided.

As in the above feature, even when the glass guide that protrudes from a boundary between the exterior sidewall portion and the external seal lip is provided, this can be integrally formed with the main body portion and the exterior seal lip and the like at the time of molding. Therefore, such a situation that a post processing is required due to provision of the glass guide, thus causing a decline in manufacturing workability can be avoided. Also, the glass guide is provided for preventing such a situation that, due to raising of the door glass with the door glass displaced to the exterior side of the vehicle, an upper edge portion of the door glass is no longer easily guided to the inside of the main body portion of the glass run. More specifically, the glass guide is provided, in order to guide the upper edge portion of the door glass to the inside of the main body portion of the glass run, in a manner protruding downward further than the exterior sidewall portion.

At least the front vertical side portion and the rear vertical side portion may be formed in a curved condition in accordance with a curvature of the mounting portion.

For a vehicle door, in design, an upper part of the door from the belt line can be formed in a curved condition so as to tilt toward the interior side of the vehicle toward the upside, for example, and accordingly, not only the door glass but also the mounting portion are formed in a curved condition. According to the above feature, at least the front vertical side portion and the rear vertical side portion of the glass run are formed in a curved condition in accordance with a curvature of the mounting portion. Thereby, in comparison with when, for example, a linearly formed glass run is made to follow the mounting portion extending while curving and mounted thereto, stabilization of amounting state, an improvement in external appearance quality, and an improvement in sealing performance can be realized.

The glass run of the invention may further comprise a function member provided with a functioning portion disposed inside the main body portion and an engaging portion to be engaged with an engaged portion provided on the base bottom portion.

The description “functioning portion” means having various functions to further improve quality when this is used as a glass run, examples of the functions include a function to absorb a shock and noise when the door glass is abutted, a function to smooth sliding of the door glass, and a function to suppress rattling of the door glass.

The glass run is for guiding raising and lowering of a door glass by locating an end edge of the door glass inside the main body portion and sealing a marginal portion of the door glass. Accordingly, generally, for an inner part of the main body portion, because this frequently slidingly contacts or is made to press-contact with the end edge of a door glass in raising and lowering (opening and shutting) of the door glass, various functions different from those in other parts are required. For example, of an inner surface of the main body portion, a part corresponding to the inside of the base bottom portion (hereinafter, simply referred to as an inner part of the base bottom portion) can be frequently abutted against a door glass in raising and lowering of said door glass. Therefore, conventionally, there are techniques such as differentiating the material of the inner part of said base bottom portion from that of other parts, and forming in a special shape (hollow shape, for example) corresponding to the inner part of the base bottom portion. However, since the spot where various functions are to be imparted is the inside of the main body portion, various difficulties have been involved in imparting the various functions, such as causing complication of an extruder or a molding device, raising the degree of difficulty of molding, complicating operation.

In this respect, according to the above technical feature, the inner part of the base bottom portion is formed by the functioning portion of the function member formed as a separate member. Therefore, in comparison with when the functioning portion is integrally molded with the glass run, the functioning portion can be relatively easily provided for the inside of the main body portion (inner portion of the base bottom portion), without causing complication of a molding device and the like.

Also, the function member may be provided either across the entire area along the longitudinal direction of the glass run or intermittently or partially.

The engaged portion may be provided partially or intermittently in a longitudinal direction of the glass run.

According to the above feature, the engaged portion is not provided across the entire area along the longitudinal direction of the glass run but is partially or intermittently provided. Therefore, such a situation that the function member is misaligned with the base bottom portion in the longitudinal direction of the glass run can be prevented. Moreover, as in the above feature, even when the engaged portion is provided partially or intermittently, this can be formed simultaneously with the base bottom portion at the time of molding. Therefore, such a situation that a post processing is required due to partial or intermittent provision of the engaged portion, thus causing a decline in manufacturing workability can be avoided.

The functioning portion may include a sub-lip that is contactable with a surface opposite to a door glass sliding-contact surface of the interior seal lip.

According to the above feature, the sub-lip contactable with the surface (rear surface) opposite to the door glass sliding-contact surface of the interior seal lip is provided. Therefore, when the door glass attempts to be displaced to the interior side of the vehicle, the interior seal lip and the sub-lip, while both are bending, support the door glass so as to push back the same in cooperation. Accordingly, rattling of the door glass can be suppressed. Moreover, since the interior seal lip is supported while being sandwiched by the sub-lip and the door glass, such a situation that the interior seal lip vibrates in the width direction of the vehicle and the interior seal lip thus separates from the door glass can be prevented. Accordingly, an improvement in sealing performance and sound insulation performance can be realized. Thus, according to the above feature, the functioning portion can display a rattling preventing function, a sealing performance improving function, and a sound insulation improving function.

At least the functioning portion of the function member provided in the upper side portion may be abutted against an inner surface of the base bottom portion to form an inner surface of the main body portion, and is formed of foam at, at least, a part that contacts the door glass.

According to the feature, the inner part of the base bottom portion to be abutted against the upper edge portion of the door glass when shutting the door glass is formed of foam. Therefore, a shock due to a knock of the door glass can be absorbed by the foam. As a result, a collision noise when shutting the door glass can be suppressed. Thus, according to the feature, the functioning portion can display a shock absorbing function.

At least the functioning portion of the function member provided in the upper side portion may be abutted against an inner surface of the base bottom portion to form an inner surface of the main body portion, and exhibits a hollow shape.

According to the above feature, the inner part of the base bottom portion to be abutted against the upper edge portion of the door glass when shutting the door glass is formed in a hollow shape. Therefore, a shock due to a knock of the door glass can be absorbed in the hollow portion. As a result, a collision noise when shutting the door glass can be suppressed. Thus, in the above feature as well, the functioning portion can display a shock absorbing function. Also, although it is considerably difficult to form a hollow shape when the entire sectional area of the glass run is molded, molding need not to be so difficult, since the function member is formed as a separate member.

At least the functioning portion of the function member provided in the front vertical side portion and the rear vertical side portion may be abutted against an inner surface of the base bottom portion to form an inner surface of the main body portion, and is made of a material harder than that of the main body portion.

According to the above feature, the inner part of the base bottom portion that slidingly contacts the door glass in opening and shutting of the door glass is made of a material harder than that of the main body portion. Therefore, slidability of the door glass and abrasion resistance of the door glass against sliding contact can be improved. Thus, according to the above feature, the functioning portion can display a slidability improving function and abrasion resistance improving function.

The functioning portion may extend, in a state before the function member is attached, laterally in a width direction from a connecting portion with the engaging portion or a vicinity thereof, in a manner tilting toward a protruding direction of he engaging portion.

According to the above feature, the functioning portion extends laterally in the width direction from a connecting portion with the engaging portion or a vicinity thereof, in a manner tilting toward the protruding direction of the engaging portion. Therefore, in an attached state of the function member, the functioning portion and the inner surface of the base bottom portion can be made press-contact. Accordingly, the functioning portion can be prevented from floating up from the base bottom portion, and a deterioration in slidability of the door glass caused by floating-up can be prevented.

The second aspect of the invention is a manufacturing method of a glass run comprising a main body portion attached to a mounting portion provided along an inner periphery of a door frame of a vehicle and having an approximately U-shape in section, the main body including a base bottom portion and an interior sidewall portion and an exterior sidewall portion extending from the base bottom portion, and an interior seal lip and an exterior seal lip extending from almost front ends of the interior sidewall portion and the exterior sidewall portion to an inside of the main body portion, wherein the manufacturing method comprising steps:
forming a cavity by a molding device including a plurality of molds,
injecting and filling a molding material into the cavity, and
integrally molding an entire longitudinal area so as to have a sectional shape having the main body portion and the interior and exterior seal lips and as to be provided with an upper side portion corresponding to an upper edge portion of a door glass and a front vertical side portion and a rear vertical side portion corresponding to a front edge portion and a rear edge portion of the door glass, respectively,
wherein an interval between the interior seal lip and the exterior seal lip at the time of molding is set to 1.5 mm or more and 3.0 mm or less, and
the molding material is an olefinic thermoplastic elastomer.

As described in the above, providing the thickness of the holding plate that holds a mold (core) for molding respective inner peripheral surfaces of the main body portion, the interior seal lip, and the exterior seal lip as 1.5 mm or more allows securing the strength of the holding plate. Moreover, providing the thickness of the holding plate as 3.0 mm or less allows providing an interval between the interior seal lip and the exterior seal lip at the time of molding as 3.0 mm or less. Thereby, sealing performance to the inner and outer surfaces of the door glass generally having a thickness of approximately 4.0 mm to 5.0 mm can be secured.

For example, when the main body portion and seal lips are made of a rubber material such as EPDM (Ethylene Propylene Diene Monomer) rubber, the EPDM or the like has a relatively high viscosity, and when intending to fill this in every corner of the cavity of the molds, it becomes necessary to provide the injection pressure as a high pressure or it becomes necessary to increase the number of gates for injection. When the former configuration is adopted, the EPDM or the like may intrude into a butting portion of a plurality of molds that form the cavity, and this may lead to burring. On the other hand, when the latter construction is adopted, this may cause complication of the mold structure. In contrast thereto, according to the above feature of the invention, since the main body portion and seal lips are made of an olefinic thermoplastic elastomer (TPO) which is lower in viscosity than EPDM or the like, burring can be prevented and complication of the mold structure can be prevented to suppress an increase in the manufacturing cost. Moreover, as a result of forming the main body portion and seal lips of a TPO, a vulcanization step is not required, so that an improvement in productivity can be realized in this point as well.

In the second aspect of the invention,
a sliding member made of a material harder than that of the main body portion may be placed on at least a part of molding surfaces forming the cavity that are to mold a door glass sliding surface of the interior seal lip and a door glass sliding surface of the exterior seal lip, and
the molding material is injected into the cavity on which the sliding member is placed so that a sliding layer is formed on the door glass sliding surface of at least either one of the interior seal lip and the exterior seal lip.

According to the second aspect of the invention, the sliding layer is simultaneously formed on the door glass sliding surface of at least either one of the interior seal lip and the exterior seal lip. Therefore, in comparison with, for example, when a step of forming the sliding layer is required separately from the molding step, an improvement in manufacturing workability is realized.

In the second aspect of the invention, a sliding member made of a material harder than that of the main body portion may be placed on at least a part of molding surfaces forming the cavity that are to mold a door glass sliding surface of the interior seal lip and a door glass sliding surface of the exterior seal lip, and
the molding material is injected into the cavity on which the sliding member is placed so that a sliding layer is formed on the door glass sliding surface of at least either one of the interior seal lip and the exterior seal lip.

According to the above feature, the same operations and effects as those of the first aspect of the invention are provided in the glass run provided with a sliding layer on the inner surface of the base bottom portion. Moreover, when, for example, a glass run is separated as two exterior and interior molded bodies at the base bottom portion and the glass run is formed by assembling both molded bodies, sliding layers corresponding to the inner surface of the base bottom portion are formed separately for the two molded bodies. In this case, required is an operation to form sliding layers corresponding to the inner surface of the base bottom portion, in molding of the two molded bodies, respectively, and this may cause a decline in manufacturing workability, complication of a mold structure, and the like. In this respect, according to the above feature, for the glass run, by molding, integrally formed is an entire longitudinal area having a sectional shape having the main body portion and the interior and exterior seal lips. More specifically, the base-portion-side sliding layer corresponding to the inner surface of the base bottom portion is formed in a single molded body. Accordingly, since one time of operation for forming the base-portion-side sliding layer is sufficient, the above-mentioned inconveniences can be prevented.

Further, a sliding member made of a material harder than that of the main body portion may be placed on a part of molding surfaces forming the cavity that are to mold an inner surface of the base bottom portion, and
the molding material is injected into the cavity on which the sliding member is placed, so that a sliding layer is formed on the inner surface of the base bottom portion.

Furthermore, sliding members made of a material harder than that of the main body portion may be placed on parts of molding surfaces forming the cavity that are to mold an inner surface of the base bottom portion, a door glass sliding surface of the interior seal lip, and a door glass sliding surface of the exterior seal lip, and
the molding material is injected into the cavity on which the sliding members are placed so that sliding layers are formed on the inner surface of the base bottom portion, the door glass sliding surface of the interior seal lip, and the door glass sliding surface of the exterior seal lip.

Further, at least the door glass sliding surfaces of the interior seal lip and the exterior seal lip are formed in a curved condition.

According to the above feature, an improvement in sealing performance can be realized by the fact that the door glass sliding surfaces, of the sealing lips, that contact with a door glass are curved surfaces. Moreover, an operation to adhere sliding members to the curved surfaces may become relatively difficult, and in particular, the above-mentioned inconveniences become remarkable since the targets of adhesion are seal lips, which are relatively easily deformed, and this may cause a decline in workability, a degradation in quality, and the like. In this respect, by adopting the construction of the above features of the invention, since the sliding layers can be formed, for the door glass sliding surfaces of the interior seal lip and the exterior seal lip, simultaneously with molding as well as at accurate positions, these inconveniences can be eliminated.

In the invention, a pair of slit portions concaved toward an outer periphery of the main body portion simultaneously with the main body portion by molding may be formed at a boundary between the base bottom portion and the interior sidewall portion and a boundary between the base bottom portion and the exterior sidewall portion, and
the sliding member provided in a manner corresponding to the inner surface of the base bottom portion is disposed between a pair of molding projections formed on the mold to mold the pair of slit portions, and both side portions of the sliding member are brought in a condition abutted against the molding projections, respectively.

According to the above feature, by using the molding projections to mold the pair of slit portions provided for easily contracting both sidewall portions when mounting the glass run to the mounting portion, the sliding member provided in a manner corresponding to the inner surface of the base bottom portion can be accurately positioned in the placing step, and misalignment of the sliding member can be prevented in the filling step.

The manufacturing method of a glass run according the invention may further comprises a positioning step of holding the sliding member in a condition closely fitted to a corresponding molding surface of the cavity,
wherein the molding material is filled in a condition where the sliding member is held.

According to the above feature, in a condition where a misalignment and floating-up of the sliding member placed in the cavity is controlled, a molding material is injected into the cavity. Therefore, a possibility such that, when a molding material is injected and filled into the cavity, the sliding member is misaligned or the molding material intrudes between the sliding member and the molding surface corresponding thereto, so that the sliding member is no longer exposed on the surface of the glass run can be prevented. Accordingly, the sliding member can be more reliably exposed on the surface at an expected position, so that the sliding layer can be more accurately formed.

The sliding member may be formed in a sheet form, and on one surface thereof, groove portions or concave portions are formed in a plurality of rows.

In the glass run according to the invention, a sliding member made of a material harder than that of the main body portion may be provided by insert molding at the time of molding so that the glass run includes a sliding layer formed on at least any one of an inner surface of the base bottom portion, a door glass sliding surface of the interior seal lip, and a door glass sliding surface of the exterior seal lip by the sliding member being exposed.

According to the invention, the upper side portion and the front and rear vertical side portions may be formed in a curved condition in accordance with a curvature of the mounting portion. Thereby, in comparison with when, for example, a linearly formed glass run is made to follow the mounting portion extending while curving and attached thereto, stabilization of amounting state, an improvement in external appearance quality, and an improvement in sealing performance can be realized. Moreover, as a result of the glass run being formed in a curved condition, an operation to adhere sliding members to the base bottom portion and the interior and exterior seal lips and may become relatively difficult, which may cause a decline in workability, a degradation in quality, and the like. These inconveniences can be eliminated, since the sliding layers can be formed simultaneously with molding of the glass run as well as at accurate positions.

Also, the positioning step may be performed, by use of a suction hole formed in a part, of a molding surface forming the cavity, where the sliding member is placed and a suction device provided so as to be capable of sucking air in the cavity via the suction hole, by sucking the sliding member placed in the cavity by the suction device. When the suction device is thus used, misalignment of the sliding member can be prevented irrespective of the shape, size, constituent material, and the like of the sliding member. Alternatively, the positioning step may be performed by using static electricity. When static electricity is thus used, since a holding force can be uniformly exerted to the entire surface of the sliding member, such a possibility that the sliding member partially floats up from the molding surface can be prevented. Further alternatively, the positioning step may be performed, in the placing step, by making end portions of the sliding member be caught by control portions protruded toward an inner peripheral side of the cavity. When the control portions are thus provided, such a situation that the end portions of the sliding member float up from the molding surface can be more reliably prevented.

According to the invention, in the placing step when a sliding layer is formed on a curved surface, the sliding member can be smoothly deformed along the molding surface to form said curved surface. Accordingly, the sliding member can be closely fitted to the molding surface relatively easily and more reliably, so that an improvement in manufacturing workability and an improvement in product quality can be realized.

Moreover, when it is provided that “in the placing step, the sliding member is placed so that a surface formed with the groove portions or concave portions faces the inside of the cavity,” the surface, of the sliding member, on the side to be buried in the molded body is increased in the surface area, so that the sliding member can be more strongly joined with the molded body.

Moreover, according to the invention, the sliding layer can be simultaneously formed in molding. Therefore, in comparison with, for example, when a step of forming the sliding layer is required separately from the molding step, an improvement in manufacturing workability is realized.

### BRIEF DESCRIPTION OF THE DRAWINGS

FIG. 1 is a schematic front view showing a schematic configuration of a door.

FIG. 2 is a sectional view along a line J-J of FIG. 1.

FIG. 3 is a sectional view of a glass run.

FIG. 4 is a sectional view along a line K-K of FIG. 1.

FIG. 5 is a sectional view showing a molding device for molding a glass run.

FIG. 6 is a side view of a door glass observed from the front side of an automobile.

FIG. 7 is a front view showing a glass run according to a modification.

FIG. 8 is a sectional view of a glass run according to a second embodiment along a line J-J of FIG. 1 showing an upper side portion.

FIG. 9 is a sectional view along a line L-L of FIG. 1 showing a rear vertical side portion.

FIG. 10 is a sectional view showing a rear vertical side portion.

FIG. 11 is a sectional view showing a molding device for molding a glass run.

FIG. 12 is a sectional view showing an upper side portion according to a modification.

FIG. 13 is a sectional view showing a rear vertical side portion according to another modification.

FIGS. 14A and 14B are perspective views showing a vertical function member according to another modification.

FIG. 15 is a sectional view of a glass run according to a third embodiment along a line L-L of FIG. 1.

FIG. 16 is a sectional view of a glass run.

FIG. 17 is a sectional view showing a molding device for molding a glass run.

FIG. 18A and 18B are partial sectional views showing a molding device according to a modification.

### DETAILED DESCRIPTION OF THE PREFERRED EMBODIMENTS

### First Embodiment

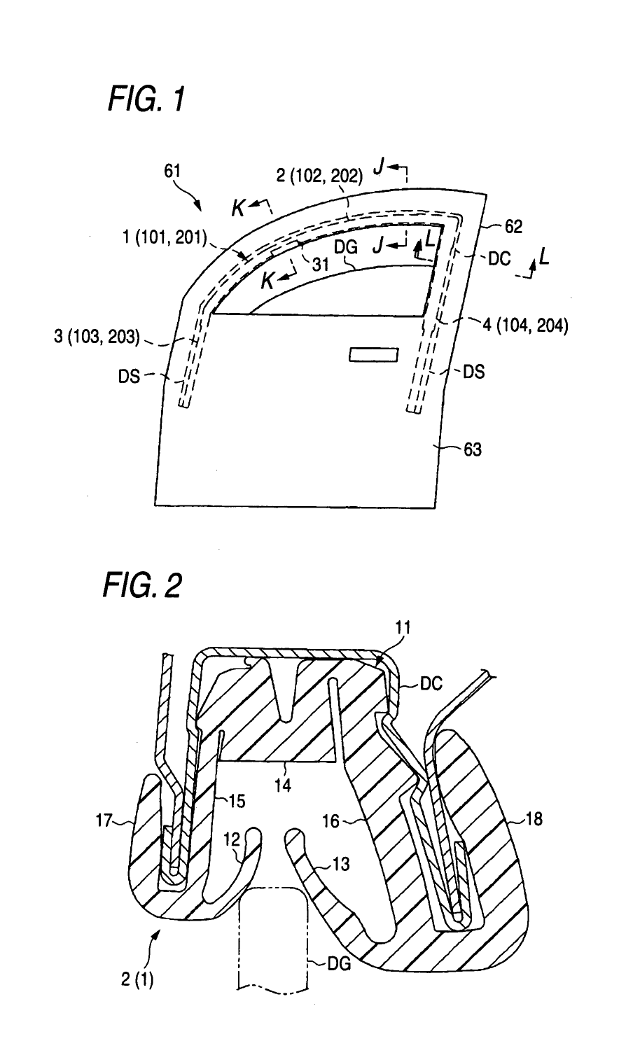

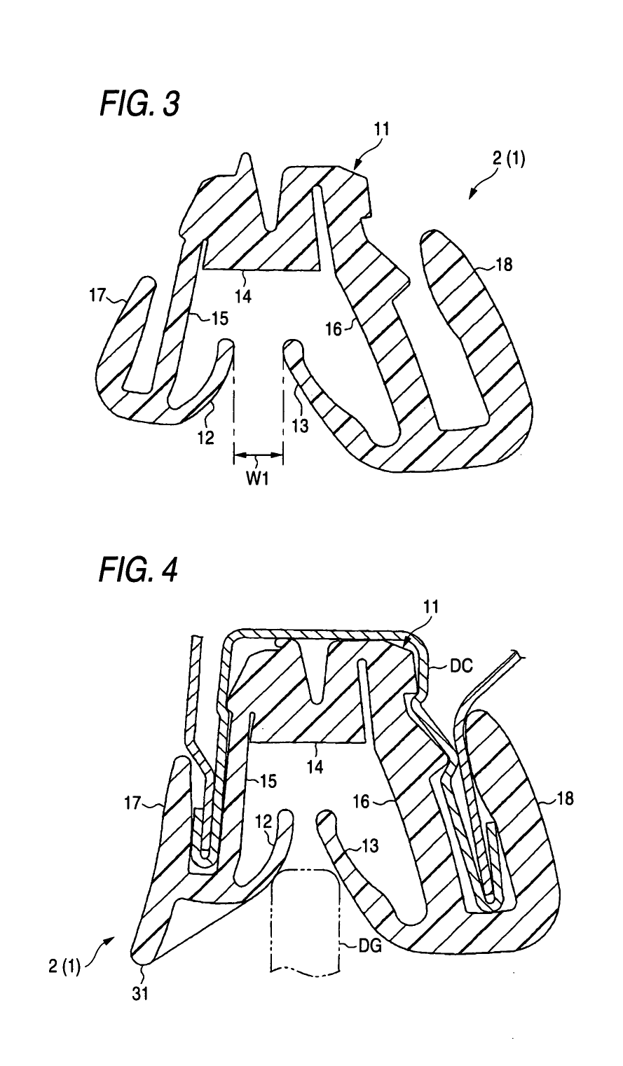

Hereinafter, a first embodiment will be described with reference to the drawings. FIG. 1 is a schematic front view showing a schematic configuration of a door. FIG. 2 is a sectional view along a line J-J of FIG. 1 showing an upper side portion of a glass run. FIG. 3 is a sectional view of a glass run not mounted to a channel portion serving as a mounting portion. FIG. 4 is a sectional view along a line K-K of FIG. 1.

As shown in FIG. 1, in an automotive door 61 (front door in the figure), provided is a glass run 1 that guides raising and lowering of a door glass DG and seals between an outer periphery of the door glass DG and a door frame 62 when the door glass DG is raised to shut a window portion. In greater detail, the glass run 1 includes an upper side portion 2 which is a part corresponding to an upper edge portion of the door glass DG, a front vertical side portion 3 which is a part extending downward from a front end portion of the upper side portion 2 and corresponding to a front edge portion of the door glass DG, and a rear vertical side portion 4 which is a part extending downward from a rear end portion of the upper side portion 2 and corresponding to a rear edge portion of the door glass DG. Said glass run 1 is mounted to the inside of a channel portion DC formed along an inner periphery of the door frame 62 and a sash portion DS provided in a door panel 63 in a manner extending front and rear vertical side portions of the channel portion DC downward. Moreover, the glass run 1 is made of a dynamically crosslinked olefinic thermoplastic elastomer (TPV).

As shown in FIG. 2 and FIG. 3, the upper side portion 2 of the glass run 1 includes a main body portion 11, an exterior seal lip 12, and an interior seal lip 13. The main body portion 11 includes a base bottom portion 14 to be fitted into the channel portion DC and an exterior sidewall portion 15 and an interior sidewall portion 16 extended from said base bottom portion 14 and forms as a whole an approximately U-shape in section. The exterior seal lip 12 extends from almost the front end of the exterior sidewall portion 15 toward an inner peripheral side of the main body portion 11, and the interior seal lip 13 extends from almost the front end of the interior sidewall portion 16 toward an inner peripheral side of the main body portion 11. In a shut state of the door glass DG, the exterior seal lip 12 is made to press-contact with an outer surface of the door glass DG, and the interior seal lip 13 is made to press-contact with an inner surface of the door glass DG. Thereby, exterior and interior sides of the door glass DG are sealed, respectively. In addition, an exterior molding lip 17 extending outward (toward the exterior side of the vehicle) from the exterior sidewall portion 15 and an interior molding lip 18 extending outward (toward the interior side of the vehicle) from the interior sidewall portion 16 are provided.

Moreover, as shown in FIG. 3, in the present embodiment, in a state before the glass run 1 is mounted to the channel portion DC, an interval W1 between a front end portion of the exterior seal lip 12 and a front end portion of the interior seal lip 13 is set within a range of 1.5 mm to 3.0 mm. On the other hand, the thickness of the door glass DG is approximately 4.0 mm to 5.0 mm. Therefore, when mounting (fitting together) the glass run 1 to the channel portion DC (sash portion DS), a marginal portion of the door glass DG can be reliably sealed by a pair of seal lips 12 and 13 without forcibly narrowing the interval between the exterior seal lip 12 and the interior seal lip 13.

In addition, the front vertical side portion 3 and the rear vertical side portion 4 also include the main body portion 11 and the pair of seal lips 12 and 13. However, of the glass run 1, with regard to a part disposed in the door panel 63 below a belt line and not appearing on the exterior (the front vertical portion 3 and a lower portion of the rear vertical side portion 4 in the present example), the exterior molding lip 17 and the interior molding lip 18 are omitted, and therein the size is reduced together with the sash portion DS to which this part is attached. Moreover, the exterior seal lip 12 is formed shorter (smaller) than the interior seal lip 13. Thereby, the door glass DG is urged to the exterior side of the vehicle, so that a flush surface can be attained. In the present embodiment, for the glass run 1, an entire longitudinal area having a sectional shape having the main body portion 11 and the interior and exterior seal lips 12 and 13 and provided with the upper side portion 2, the front vertical side portion 3, and the rear vertical side portion 4 is integrally formed by molding.

Further, an upper part of the door 61 from the belt line is formed in a curved condition so as to tilt toward the interior side of the vehicle. As a result of the door 61 being thus formed, not only the door glass DG (see a sectional view when the door glass DG of FIG. 6 was cut into the front and rear pieces) but also the channel portion DC are formed in a curved condition. In the present embodiment, at least the front vertical side portion 3 and the rear vertical side portion 4 are formed in a curved condition in accordance with a curvature of the channel portion DC described above. More specifically, the front vertical side portion 3 and the rear vertical side portion 4 are formed in a curved condition so as to tilt toward the interior side of the vehicle.

Moreover, as shown in FIG. 1 and FIG. 4, in the present embodiment, the upper side portion 2 is provided with a glass guide 31 that is protruded downward (an inner periphery side of the window portion of the door 61) from a boundary between the exterior sidewall portion 15 and the exterior seal lip 12. Due to the existence of said glass guide 31, even when the door glass DG sliding upward is displaced to the exterior side of the vehicle, the upper edge portion of said door glass DG can be smoothly guided to the inside of the main body portion 11. Moreover, the glass guide 31 is, in molding of the glass run 1, integrally formed with the exterior sidewall portion 15 and the exterior seal lip 12, and the like.

Also, an inner surface of the base bottom portion 14, a door glass sliding surface of the seal lip 12, 13, and the like are applied with a surface treatment in order to improve slidability of the door glass DG. Examples of the surface treatment include adhering a polyethylene (PE) tape or the like to the inner surface of the base bottom portion 14 to form a sliding layer and forming a coating (urethane coating, for example) on the surface of the seal lip 12, 13.

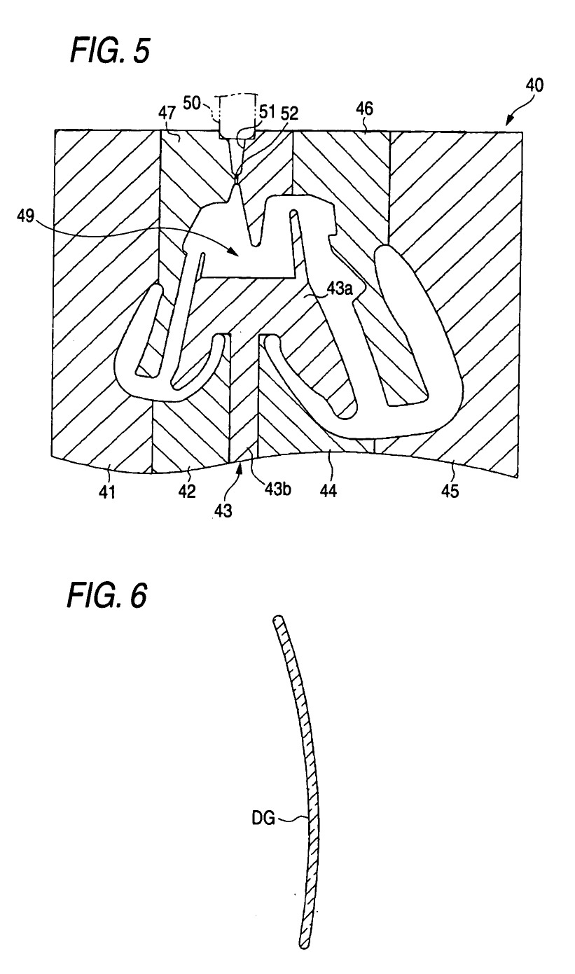

Next, a manufacturing method of the glass run 1 will be described in greater detail. The glass run 1 according to the present embodiment is molded, for example, by use of a molding device 40 as shown in FIG. 5. More specifically, the molding device 40 includes a first mold 41, a second mold 42, a third mold 43, a fourth mold 44, a fifth mold 45, a sixth mold 46, and a seventh mold 47. Also, the third mold 43 is composed of a core mold 43a that molds respective inner peripheral surfaces of the main body portion 11, the exterior seal lip 12, and the interior seal lip 13 and a holding plate 43b that holds said core mold 43a. On these molds 41 to 47, formed are molding surfaces corresponding to an outer shape of the glass run 1, respectively, and these molding surfaces form a cavity 49 to mold the glass run 1.

Of the cavity 49, parts corresponding to the front and rear vertical side portions 3 and 4 are curved, as described above, so that the front and rear vertical side portions 3 and 4 tilt toward the interior side of the vehicle. Moreover, in the present embodiment, the thickness of the holding plate 43b of the third mold 43 is set to be 1.5 mm to 3.0 mm.

Next, a TPV in a plasticized state is injected by an injection device 50 into the cavity 49 via a sprue 51 and a gate 52 formed in the seventh mold 47, and filled. After completion of solidification, mold opening is performed to remove the molded glass run 1 from the molding device 40. Thereby, an entire longitudinal area of the glass run 1 having a sectional shape having the main body portion 11 and the seal lips 12 and 13 and provided with the upper side portion 2, the front vertical side portion 3, and the rear vertical side portion 4 is molded as in the above. Thereafter, by applying a surface treatment to the base bottom portion 14 and the seal lips 12 and 13, the glass run 1 is manufactured.

As has been described in detail above, in the present embodiment, the entire longitudinal area of the glass run 1 is formed by molding. Therefore, as in, for example, the case where the glass run 1 is composed of extruded bodies and a molded body, such a situation that a connection line between the extruded body and molded body appears on the exterior can be avoided. Moreover, such a situation that a difference in color and luster partially occurs in the longitudinal direction (circumferential direction) of the glass run 1 can be avoided. As a result, an improvement in external appearance quality can be realized. Furthermore, such a possibility that an unnecessary step is formed in the longitudinal direction of the glass run 1 can be avoided, so that an improvement in sealing performance can be realized.

Moreover, since a molded body is higher in the degree of freedom of product design than an extruded body, even when, for example, a glass run is differentiated in the sectional shape at a specific part, this can be easily molded by molding. In the present embodiment, although it has been provided to provide the glass guide 31 for the upper side portion 2, this is formed, at the time of molding, simultaneously with other parts, without performing a separate operation, such as partially cutting away the exterior sidewall portion 15 after molding of the glass run 1 or separately molding a glass guide. Further, in the present embodiment, although a part of the glass run 1 below the belt line (lower portion of the rear vertical side portion 4 and the front vertical side portion 3) has been formed in a shape where the exterior molding lip 17 and the interior molding lip 18 are omitted, this is formed, in molding, simultaneously with other parts, without performing a separate operation such as cutting the exterior molding lip 17 and the interior molding lip 18. Therefore, such a situation that a separate operation (post processing) is required for differentiating the sectional shape at a specific part can be avoided, so that an improvement in productivity can be realized.

Moreover, in comparison with, for example, when the glass run 1 is formed by assembling a plurality of molded bodies, an improvement in manufacturing workability is realized since no assembling operation is required, and the cost can be reduced since one molding device is sufficient. Further, a possibility such that a misalignment and detachment of a plurality of molded bodies to compose a glass run causes a decline in sealing performance, a deterioration in a mounting state to a mounting portion, and a decline in mounting workability can be prevented.

Further, at the time of molding, the interval W1 between the interior seal lip 13 and the exterior seal lip 12 has been set to 1.5 mm or more and 3.0 mm or less. Providing the interval between the interior seal lip 13 and the exterior seal lip 12 as 1.5 mm or more allows securing the strength of the third mold 43 (holding plate 43b) to mold the respective inner peripheral surfaces of the main body portion 11, the exterior seal lip 12, and the interior seal lip 13. Moreover, providing the interval between the interior seal lip 13 and the exterior seal lip 12 as 3.0 mm or less allows saving forcibly narrowing the interval between the seal lips 12 and 13 thereafter, so that sealing performance to the marginal portions of the inner and outer surfaces of the door glass DG with a thickness of approximately 4.0 mm to 5.0 mm can be secured.

Moreover, the glass run 1 (the main body portion 11 and the seal lips 12 and 13) is made of a TPV. For example, when the glass run 1 is made of a rubber material such as EPDM, the EPDM or the like has a relatively high viscosity, and when intending to fill this in every corner of the cavity 49 of the molding device 40, it becomes necessary to provide the injection pressure as a high pressure or it becomes necessary to increase the number of gates for injection. When the former construction is adopted, the EPDM or the like may intrude into a butting portion of a plurality of molds that form the cavity 49, and this may lead to burring. On the other hand, when the latter construction is adopted, this may cause complication of the mold structure. In contrast thereto, according to the present embodiment, since the glass run 1 is made of a TPV which is lower in viscosity than EPDM or the like, burring can be prevented and complication of the mold structure can be prevented to suppress an increase in the manufacturing cost. Moreover, as a result of forming the glass run 1 of a TPV, a vulcanization step is not required, so that an improvement in productivity can be realized.

Further, in molding, the upper side portion 2, the front vertical side portion 3, and the rear vertical side portion 4 are formed in accordance with the curvature of the channel portion DC. Thereby, in comparison with when, for example, a linearly formed glass run is made to follow the channel portion DC extending while curving and attached thereto, stabilization of a mounting state, an improvement in external appearance quality, and an improvement in sealing performance can be realized.

In addition, generally, molded bodies have a smaller variation (manufacturing error) of the sectional shapes, and the glass run 1 (main body of glass run 1) according to the present embodiment is composed only of molded bodies (21, 22), and thus an improvement in quality can be realized. Moreover, in comparison with when the glass run 1 is composed of extruded bodies and a molded body, an improvement in working efficiency, simplification of equipment, and the like can be realized, and moreover, an improvement in productivity, a reduction in cost, and the like can be realized.

Also, without being limited to the contents of description of the above embodiment, the present invention may be carried out, for example, as follows. As a matter of course, other applications and modifications not exemplified in the following can also be made.

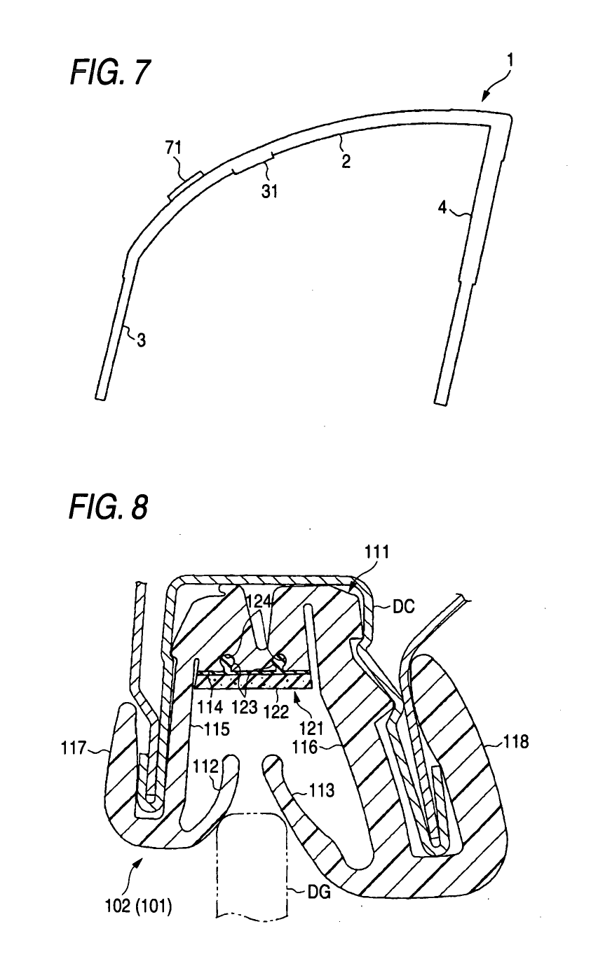

(a) As shown in FIG. 7, at a part of the upper side portion 2 closer to the front vertical side portion 3, a buffering projection 71 that is protruded upward from the base bottom portion 14 and buffers a shock when the door glass DG is shut may be provided. Thus, even when the buffering projection 71 is provided, this can be integrally formed with other parts at the time of molding. Therefore, such a situation that a post processing is required due to provision of the buffering projection 71, thus causing a decline in manufacturing workability can be avoided.

Moreover, although illustration is omitted, a deviation preventing protrusion that is protruded upward from the base bottom portion 14 of the upper side portion 2 and controls a deviation movement of the glass run 1 in the longitudinal direction by being latched with a hole portion or a concave portion formed in the channel portion DC in a state where the glass run 1 is attached to the channel portion DC may be provided. Thus, even when the deviation preventing protrusion is provided, this can be integrally formed with other parts at the time of molding of the glass run 1. Also, the deviation preventing protrusion may be formed by insert molding. In addition, the glass guide 31 can also be omitted.

(b) In the above embodiment, although the glass run 1 is made of a TPV, the present invention is not particularly limited to such a construction, and the glass run 1 may be made of, for example, a non-crosslinked olefinic thermoplastic elastomer (TPO). Moreover, in the above embodiment, although the glass run 1 of the front door has been particularly described in detail, with regard to a glass run and the like of the rear door as well, an entire longitudinal area may be formed by molding.

Also, in FIG. 5, although the holding plate 43b of the third mold 43 is formed with a slightly smaller thickness than the interval between a molding surface to mold the exterior seal lip 12 and a molding surface to mold the interior seal lip 13 (that is, the interval between the exterior seal lip 12 and the interior seal lip 13 at the time of molding), the holding plate 43b may be formed with the same thickness as the interval between the exterior seal lip 12 and the interior seal lip 13 at the time of molding.

### Second Embodiment

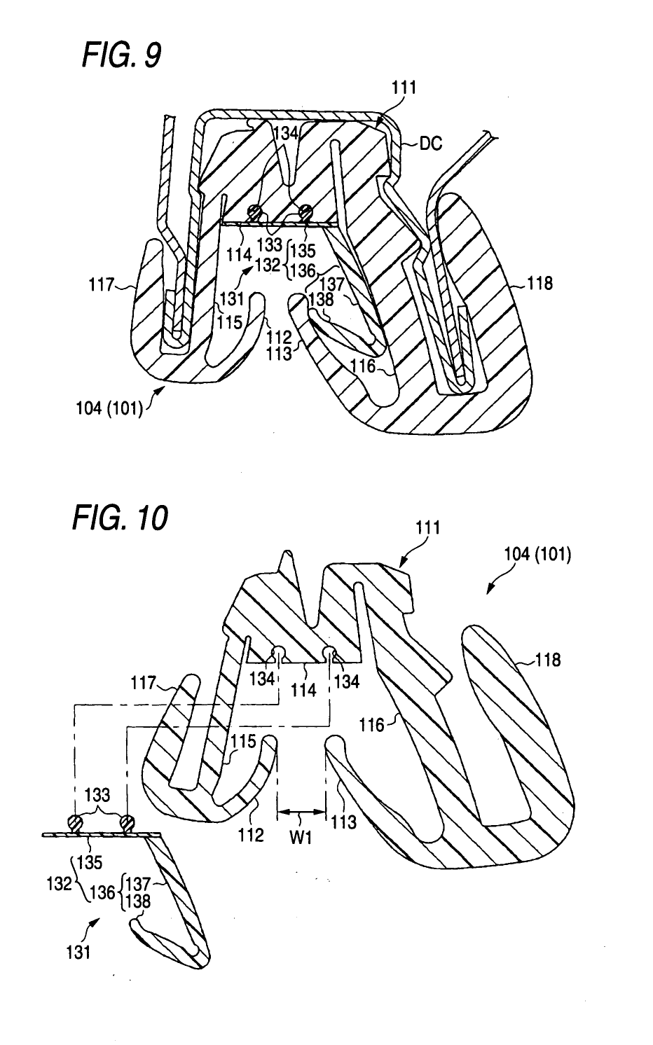

Hereinafter, a second embodiment will be described with reference to the drawings. FIG. 8 is a sectional view along a line J-J of FIG. 1 showing an upper side portion of a glass run. FIG. 9 is a sectional view along a line L-L of FIG. 1 showing a rear vertical side portion of a glass run. FIG. 10 is a sectional view showing a rear vertical side portion of a glass run not mounted to a channel portion serving as a mounting portion.

Similarly to the first embodiment, as shown in FIG. 1, in an automotive door 61 (front door in the figure), provided is a glass run 101 that guides raising and lowering of a door glass DG and seals between an outer periphery of the door glass DG and a door frame 62 when the door glass DG is raised to shut a window portion. In greater detail, the glass run 101 includes an upper side portion 102 which is a part corresponding to an upper edge portion of the door glass DG, a front vertical side portion 103 which is a part extending downward from a front end portion of the upper side portion 102 and corresponding to a front edge portion of the door glass DG, and a rear vertical side portion 104 which is a part extending downward from a rear end portion of the upper side portion 102 and corresponding to a rear edge portion of the door glass DG. And, said glass run 101 is mounted to the inside of a channel portion DC formed along an inner periphery of the door frame 62 and a sash portion DS provided in a door panel 63 in a manner extending front and rear vertical side portions of the channel portion DC downward.

As shown in FIG. 8, the upper side portion 102 of the glass run 101 includes a main body portion 111, an exterior seal lip 112, and an interior seal lip 113. The main body portion 111 includes a base bottom portion 114 to be fitted into the channel portion DC and an exterior sidewall portion 115 and an interior sidewall portion 116 extended from said base bottom portion 114 and forms as a whole an approximately U-shape in section. The exterior seal lip 112 extends from almost the front end of the exterior sidewall portion 115 toward an inner peripheral side of the main body portion 111, and the interior seal lip 113 extends from almost the front end of the interior sidewall portion 116 toward an inner peripheral side of the main body portion 111. And, in a shut state of the door glass DG, the exterior seal lip 112 is made to press-contact with an outer surface of the door glass DG, and the interior seal lip 113 is made to press-contact with an inner surface of the door glass DG. Thereby, exterior and interior sides of the door glass DG are sealed, respectively. In addition, an exterior molding lip 117 extending outward (toward the exterior side of the vehicle) from the exterior sidewall portion 115 and an interior molding lip 118 extending outward (toward the interior side of the vehicle) from the interior sidewall portion 116 are provided. In the present embodiment, the main body portion 111, the seal lips 112 and 113, and the molding lips 117 and 118 are made of a dynamically crosslinked olefinic thermoplastic elastomer (TPV).

In addition, the front vertical side portion 103 and the rear vertical side portion 104 (see FIG. 9) also include the main body portion 111 and the pair of seal lips 112 and 113. However, of the glass run 101, with regard to a part disposed in the door panel 63 below a belt line and not appearing on the exterior (the front vertical portion 103 and a lower portion of the rear vertical side portion 104 in the present example), the exterior molding lip 117 and the interior molding lip 118 are omitted, and therein the size is reduced together with the sash portion DS to which this part is attached. Moreover, the exterior seal lip 112 is formed shorter (smaller) than the interior seal lip 113. Thereby, the door glass DG is urged to the exterior side of the vehicle, so that a flush surface can be attained. In the present embodiment, for the glass run 101, an entire longitudinal area having a sectional shape having the main body portion 111 and the interior and exterior seal lips 112 and 113 and provided with the upper side portion 102, the front vertical side portion 103, and the rear vertical side portion 104 is integrally formed by molding.

Moreover, as shown in FIG. 10, in the present embodiment, in a state before the glass run 1 is mounted to the channel portion DC, an interval W1 between a front end portion of the exterior seal lip 112 and a front end portion of the interior seal lip 113 is set within a range of 1.5 mm to 3.0 mm. On the other hand, the thickness of the door glass DG is approximately 4.0 mm to 5.0 mm. Therefore, when mounting (fitting together) the glass run 101 to the channel portion DC (sash portion DS), a marginal portion of the door glass DG can be reliably sealed by a pair of seal lips 112 and 113 without forcibly narrowing the interval between the exterior seal lip 112 and the interior seal lip 113.

Now, as shown in FIG. 8, the upper side portion 102 is provided with an upper function member 121. The upper function member 121 includes a functioning portion 122 disposed inside the main body portion 111 and an engaging portion 123 protruded from said functioning portion 122 and engaged with an engaged portion 124 formed on an inner surface of the base bottom portion 114. The engaging portion 123 according to the present embodiment is formed as a protrusion provided at its front end with an enlarged diameter portion having an almost circular shape in section, and the engaged portion 124 is formed as a hole portion having a shape corresponding to the engaging portion 123 (as a matter of course, both may be placed in an opposite relationship.) Then, by engaging the engaging portion 123 with the engaged portion 124, the upper function member 121 is attached to the base bottom portion 114. In the present embodiment, the engaging portion 123 and the engaged portion 124 are provided at every predetermined interval along a longitudinal direction of the glass run 101. Thus, by intermittently providing the engaged portions 124, such a situation that the upper function member 121 is misaligned, with respect to the base bottom portion 114 in the longitudinal direction of the glass run 101 can be avoided.

Moreover, the functioning portion 122 is formed in a rectangular parallelepiped shape in section, and in an attached state of the upper function member 121, is abutted on its surface against the inner surface of the base bottom portion 114. Thereby, of an inner surface of the main body portion 111, a part corresponding to the inside of the base bottom portion 114 (hereinafter, simply referred to as an inner part of the base bottom portion 114) is formed by a functioning portion 122, and said functioning portion 122 is abutted against the upper edge portion of the door glass DG when the door glass DG is shut. Further, for the upper function member 121, the engaging portion 123 is made of a solid EPDM, and a major part (lower part) of the functioning portion 122 is made of a sponge EPDM. Moreover, the functioning portion 122 (part of the functioning portion 122 made of a sponge EPDM) is formed with a larger thickness than that of a functioning portion 132 to be described later so that a shock caused by abutting of the door glass DG can be sufficiently absorbed.

As shown in FIG. 9, the rear vertical side portion 104 (front vertical side portion 103) is provided with a vertical function member 131. The vertical function member 131 includes a functioning portion 132 disposed inside the main body portion 111 and an engaging portion 133 protruded from said functioning portion 132 and engaged with an engaged portion 134 formed on an inner surface of the base bottom portion 114. The engaging portion 133 according to the present embodiment is formed as a protrusion provided at its front end with an enlarged diameter portion having an almost circular shape in section, and the engaged portion 134 is formed as a hole portion having a shape corresponding to the engaging portion 133. The engaging portion 133 and the engaged portion 134 are also provided at every predetermined interval along a longitudinal direction of the glass run 101.

The functioning portion 132 includes a sheet-like base portion 135 that is abutted on its surface against the inner surface of the base bottom portion 114 in an attached state of the vertical function member 131 and a lip forming portion 136 that is contactable with a surface (rear surface) opposite to a door glass sliding-contact surface of the interior seal lip 113.

The lip forming portion 136 is provided with an extension portion 137 extending in a manner following the inside of the interior sidewall portion 116 from an end portion, of the base portion 135, on the interior sidewall portion 116 side up to the front end portion side of the interior sidewall portion 116 further than the front end portion of the interior seal lip 113 and a sub-lip 138 linearly extending from a front end portion of the extension portion 137 toward the inner peripheral side of the main body portion 111 while tilting toward the base bottom portion 114 side and contactable with the rear surface of the front end part of the interior seal lip 113.

Moreover, the base portion 135 that forms an inner part of the base bottom portion 114 and slidingly contacts a vertical edge portion of the door glass DG in raising and falling of said door glass DG is made of polyethylene harder than EPDM. On the other hand, the engaging portion 133 and the lip forming portion 136 are made of a TPV. Moreover, the base portion 135 is formed with a small thickness so that, when mounting the glass run 101 to the channel portion DC and attaching the vertical function member 131 to the base bottom portion 114, mounting workability and shape followability do not decline due to an excessively high rigidity. Also, in the present embodiment, for each of the function members 121 and 131 corresponding to the respective side portions 102, 103, and 104, the functioning portion, 122, 132 and the engaging portion 123, 133 are integrally molded.

Also, a door glass sliding surface of the seal lip 112, 113 and the like is applied with a surface treatment in order to improve slidability of the door glass DG. Examples of the surface treatment include forming a coating (urethane coating, for example) on the surface of the sealing lip 112, 113.

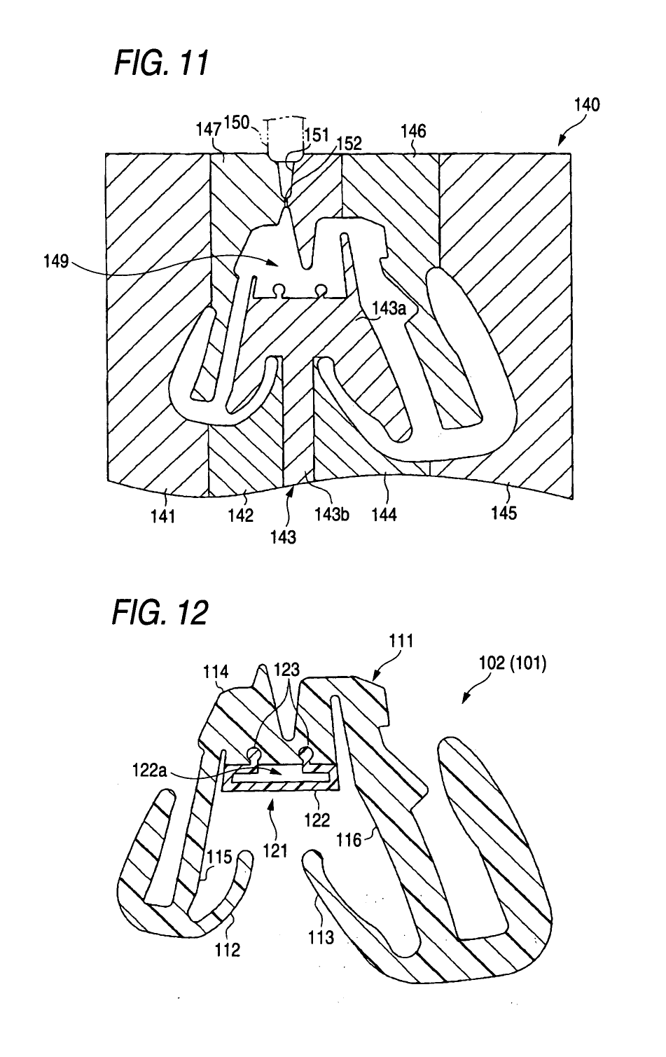

Next, a manufacturing method of the glass run 101 will be described in greater detail. The glass run 101 according to the present embodiment is molded, for example, by use of a molding device 140 as shown in FIG. 11. More specifically, the molding device 140 includes a first mold 141, a second mold 142, a third mold 143, a fourth mold 144, a fifth mold 145, a sixth mold 146, and a seventh mold 147. Also, the third mold 143 is composed of a core mold 143a that molds respective inner peripheral surfaces of the main body portion 111, the exterior seal lip 112, and the interior seal lip 113 and a holding plate 143b that holds said core mold 143a. On these molds 141 to 147, formed are molding surfaces corresponding to an outer shape of the glass run 101, respectively, and these molding surfaces form a cavity 149 to mold the glass run 101. Moreover, in the present embodiment, it is set so that the thickness of the holding plate 143b of the third mold 143 becomes 1.5 mm to 3.0 mm.

Next, a TPV in a plasticized state is injected by an injection device 150 into the cavity 149 via a sprue 151 and a gate 152 formed in the seventh mold 147, and filled. After completion of solidification, mold opening is performed to remove the molded glass run 101 from the molding device 140. Thereby, an entire longitudinal area of the glass run 101 having a sectional shape having the main body portion 111, the seal lips 112 and 113, and engaged portions 124 and 134 and provided with the upper side portion 102, the front vertical side portion 103, and the rear vertical side portion 104 is molded continuously. Thereafter, by applying a surface treatment to the base bottom portion 114 and the seal lips 112 and 113, the glass run 101 is manufactured.

Moreover, the upper function member 121 and the vertical function member 131 are separately formed by a predetermined molding device. Then, by attaching the upper function member 121 to the upper side portion 102 and attaching the vertical function member 131 to the front and rear vertical side portions 103 and 104, the glass run 101 having a sectional shape as in the above is formed. Thereafter, a surface treatment is applied to the seal lips 112 and 113 to thereby manufacture the glass run 101.

As has been described in detail above, in the present embodiment, the entire longitudinal area of the glass run 101 is formed by molding. Therefore, as in, for example, the case where the glass run 101 is formed by connecting extruded bodies and a molded body in the longitudinal direction, such a situation that a connection line between the extruded body and molded body appears on the exterior can be avoided. Moreover, such a situation that a difference in color and luster partially occurs in the longitudinal direction (circumferential direction) of the glass run 101 can be avoided. As a result, an improvement in external appearance quality can be realized. Furthermore, such a possibility that an unnecessary step is formed in the longitudinal direction of the glass run 101 can be avoided, so that an improvement in sealing performance can be realized.

Moreover, in comparison with, for example, when the glass run 101 is formed by assembling a plurality of molded bodies, an improvement in manufacturing workability is realized since no assembling operation is required, and the cost can be reduced since one molding device is sufficient. Further, a possibility such that a misalignment and detachment of a plurality of molded bodies to compose a glass run causes a decline in sealing performance, a deterioration in a mounting state to a mounting portion, and a decline in mounting workability can be prevented.

Moreover, according to the present embodiment, the upper function member 121 is provided for the upper side portion 102 and the vertical function member 131 is provided for the front and rear vertical side portions 103 and 104.

Moreover, in greater detail, most of the functioning portion 122 of the upper function member 121 to be abutted against the upper edge portion of the door glass DG when the door glass DG is shut is formed of foam. Therefore, this can absorb a shock due to a knock of the door glass DG, and as a result, a collision noise when shutting the door glass DG can be suppressed.

Moreover, the base portion 135 of the functioning portion 132 of the vertical function member 131 to be abutted against the front and rear vertical edge portions of the door glass DG when raising and lowering the door glass DG is made of polyethylene harder than the base bottom portion 114 made of a TPV. Therefore, slidability of the door glass DG and abrasion resistance of the door glass DG against sliding contact can be improved.

Further, on the functioning portion 132 of the vertical function member 131, provided is the sub-lip 138 contactable with the surface (rear surface) opposite to the door glass sliding-contact surface of the interior seal lip 113. Therefore, when the door glass DG attempts to be displaced to the interior side of the vehicle, the interior seal lip 113 and the sub-lip 138, while both are bending, support the door glass DG so as to push back the same in cooperation. Accordingly, rattling of the door glass can be suppressed. Moreover, since the interior seal lip 113 is supported while being sandwiched by the sub-lip 138 and the door glass DG, such a situation that the interior seal lip 113 vibrates in the width direction of the vehicle and the interior seal lip 113 thus separates from the door glass DG can be prevented. Accordingly, an improvement in sealing performance and sound insulation performance can be realized.

Moreover, since a molded body is higher in the degree of freedom of product design than an extruded body, even when, for example, a glass run is differentiated in the sectional shape at a specific part, this can be easily molded by molding. In the present embodiment, although it has been provided to provide the engaged portions 124 and 134 at every predetermined interval in the longitudinal direction of the glass run 101, these are formed, at the time of molding, simultaneously with other parts, without performing a separate operation, such as partially cutting away the base bottom portion 114 after molding of the glass run 101. Further, in the present embodiment, although a part of the glass run 101 below the belt line (lower portion of the rear vertical side portion 104 and the front vertical side portion 103) has been formed in a shape where the exterior molding lip 117 and the interior molding lip 118 are omitted, this is formed, in molding, simultaneously with other parts, without performing a separate operation such as cutting the exterior molding lip 117 and the interior molding lip 118. Therefore, such a situation that a separate operation (post processing) is required for differentiating the sectional shape at a specific part can be avoided, so that an improvement in productivity can be realized.

Further, at the time of molding, the interval W1 between the interior seal lip 113 and the exterior seal lip 112 has been set to 1.5 mm or more and 3.0 mm or less. Providing the interval between the interior seal lip 113 and the exterior seal lip 112 as 1.5 mm or more allows securing the strength of the third mold 143 (holding plate 143b) to mold the respective inner peripheral surfaces of the main body portion 111, the exterior seal lip 112, and the interior seal lip 113. Moreover, providing the interval between the interior seal lip 113 and the exterior seal lip 112 as 3.0 mm or less allows saving forcibly narrowing the interval between the seal lips 112 and 113 thereafter, so that sealing performance to the marginal portions of the inner and outer surfaces of the door glass DG with a thickness of approximately 4.0 mm to 5.0 mm can be secured.

Moreover, the main body portion 111 and the seal lips 112 and 113 are made of a TPV. For example, when the main body portion 111 and the seal lips 112 and 113 are made of a rubber material such as EPDM, the EPDM or the like has a relatively high viscosity, and when intending to fill this in every corner of the cavity 149 of the molding device 140, it becomes necessary to provide the injection pressure as a high pressure or it becomes necessary to increase the number of gates for injection. When the former construction is adopted, the EPDM or the like may intrude into a butting portion of a plurality of molds that form the cavity 149, and this may lead to burring. On the other hand, when the latter construction is adopted, this may cause complication of the mold structure. In contrast thereto, according to the present embodiment, since the main body portion 111 and the seal lips 112 and 113 are made of a TPV which is lower in viscosity than EPDM or the like, burring can be prevented and complication of the mold structure can be prevented to suppress an increase in the manufacturing cost. Moreover, as a result of forming the main body portion 111 and the seal lips 112 and 113 of a TPV, a vulcanization step is not required, so that an improvement in productivity can be realized.

Also, without being limited to the contents of description of the above embodiment, the present invention may be carried out, for example, as follows. As a matter of course, other applications and modifications not exemplified in the following can also be made.

(a) As shown in FIG. 12, the functioning portion 122 of the upper function member 121 may be formed in a hollow shape. Thereby, a hollow portion 122a is formed in the inner part of the base bottom portion 114 that is abutted against the upper edge portion of the door glass DG when shutting the door glass DG. In this case, a shock based on abutting of the door glass DG can be absorbed by repulsion of the hollow portion 122a, and a collision noise when shutting the door glass DG can be more reliably suppressed. Also, although it is considerably difficult to form a hollow shape when the entire sectional area of the glass run 101 is molded, by forming the upper function member 121 as a separate member, molding need not to be so difficult.

Also, it is possible to omit the upper function member 121 and the engaged portion 124. Moreover, a buffering projection that is protruded upward from the base bottom portion 114 of the upper side portion 102 and buffers a shock when the door glass DG is shut may be provided. Moreover, a deviation preventing protrusion that is protruded upward from the base bottom portion 114 of the upper side portion 102 and controls a deviation movement of the glass run 101 in the longitudinal direction by being latched with a hole portion or a concave portion formed in the channel portion DC in a state where the glass run 101 is mounted to the channel portion DC may be provided. Further, the upper side portion 102 may be provided with a glass guide protruded downward from a boundary between the exterior sidewall portion 115 and the exterior seal lip 112 and for guiding, when the rising door glass DG is displaced to the exterior side of the vehicle, the upper edge portion of said door glass DG to the inside of the main body portion 111. Thus, even when the buffering projection, the deviation preventing protrusion, the glass guide, and the like are provided, these can be integrally formed with other parts at the time of molding. Therefore, such a situation that a post processing is required due to provision of the buffering projection, the deviation preventing protrusion, the glass guide, and the like, thus causing a decline in manufacturing workability can be avoided. Also, the deviation preventing protrusion may be insert-molded in molding of the glass run 101.

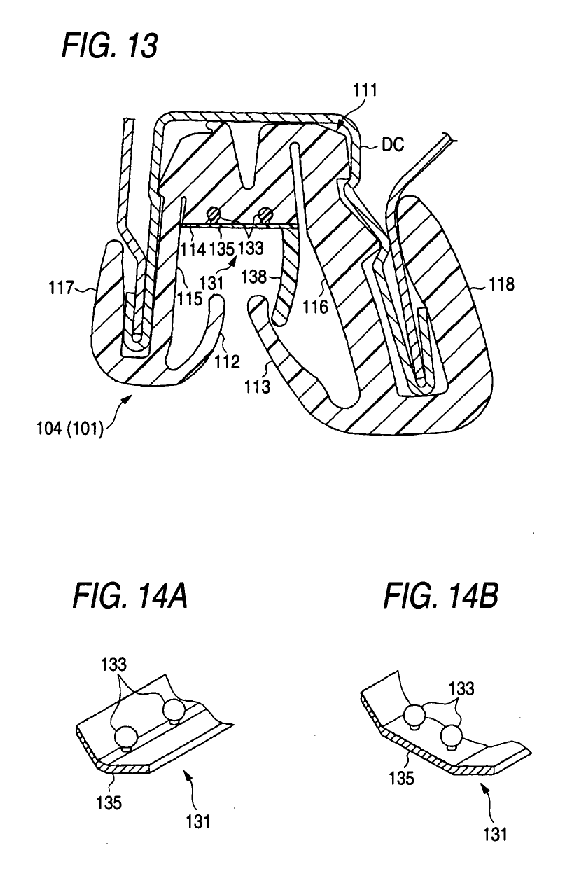

(b) In the above embodiment, although the sub-lip 138 provided in the vertical function member 131 is formed so as to extend from the front end portion of the extension portion 137 extended from the base portion 135 toward the base bottom portion 114 side, the present invention is not particularly limited to such a construction, it suffices that the sub-lip 138 is formed contactable with the surface (rear surface) opposite to the door glass sliding-contact surface of the interior seal lip 113. For example, as shown in FIG. 13, the sub-lip 138 maybe extended from the end portion on the interior sidewall portion 116 side of the base portion 135 of the vertical function member 131 toward the rear surface of the front end part of the interior seal lip 113.

(c) The lip forming portion 136 of the vertical function member 131 according to the above embodiment may be omitted. Moreover, as shown in FIG. 14A and 14B, the base portion 135 of the vertical function member 131 may be formed, in a state before the vertical function member 131 is attached, so as to extend laterally from a connecting portion with the engaging portion or a vicinity thereof in a manner tilting toward the protruding direction of the engaging portion 133. In this case, in an attached state of the vertical function member 131, the base portion 135 and the inner surface of the base bottom portion 114 can be made press-contact. Accordingly, the functioning portion 122 can be prevented from floating up from the base bottom portion 114, and a deterioration in slidability of the door glass DG caused by floating-up can be prevented.

Moreover, it is also possible to omit the vertical function member 131 and the engaged portion 134. In this case, to the inner surface of the base bottom portion 114 of the vertical side portion 103, 104, a polyethylene (PE) tape or the like may be adhered to form a sliding layer, or a coating (urethane coating, for example) may be formed, for example.

(d) In the above embodiment, although the main body portion 11 and the seal lips 112 and 113 are made of a TPV, the present invention is not particularly limited to such a construction, and these maybe made of, for example, a non-crosslinked olefinic thermoplastic elastomer (TPO).

Moreover, although the upper function member 121 is made of EPDM, this may be made of another material such as a TPO. However, it is desirable that the functioning portion 122 of the upper function member 121 has a function to absorb a shock caused by abutting of the door glass DG. Further, although the engaging portion 133 and the lip forming portion 136 of the vertical function member 131 is made of a TPV and the base portion 135 is made of polyethylene, the engaging portion 133 and the lip engaging portion 136 may be made of a non-crosslinked olefinic thermoplastic elastomer and EPDM, and the base portion 135 may be formed of polypropylene and other materials. However, it is desirable that the base portion 135 of the vertical function member 131 is made of a material harder than the base bottom portion 114. Also, by forming the engaging portions 123 and 133 of a material (material harder than EPDM, for example) that is hard to some extent, an improvement in mounting workability of the function members 121 and 131 to the base bottom portion 114 (engaged portions 124 and 134) can be improved.

Moreover, in the above embodiment, although the glass run 101 of the front door has been particularly described in detail, with regard to a glass run and the like of the rear door as well, an entire longitudinal area may be integrally formed by molding, and the upper function member 121 and the vertical function member 131 may be provided. Further, the present invention can also be applied to a glass run having a sectional shape without the molding lips 117 and 118, for example.

Also, in FIG. 11, although the holding plate 143b of the third mold 143 is formed with a slightly smaller thickness than the interval between a molding surface to mold the exterior seal lip 112 and a molding surface to mold the interior seal lip 113 (that is, the interval between the exterior seal lip 112 and the interior seal lip 113 at the time of molding), the holding plate 143b may be formed with the same thickness as the interval between the exterior seal lip 112 and the interior seal lip 113 at the time of molding.

(e) Moreover, at the time of molding, at least the front vertical side portion 103 and the rear vertical side portion 104 may be formed in a curved condition in accordance with a curvature of the channel portion DC. More specifically, for the door 61, in design, an upper part of the door 61 from the belt line can be formed in a curved condition so as to tilt toward the interior side of the vehicle, and accordingly, not only the door glass DG but also the channel portion DC are formed in a curved condition. By thus forming the front vertical side portion 103 and the rear vertical side portion 104 of the glass run 101 in a curved condition in accordance with a curvature of the channel-portion DC, in comparison with when, for example, a linearly formed glass run is made to follow the channel portion DC extending while curving and attached thereto, stabilization of a mounting state, an improvement in external appearance quality, and an improvement in sealing performance can be realized.

### Third Embodiment

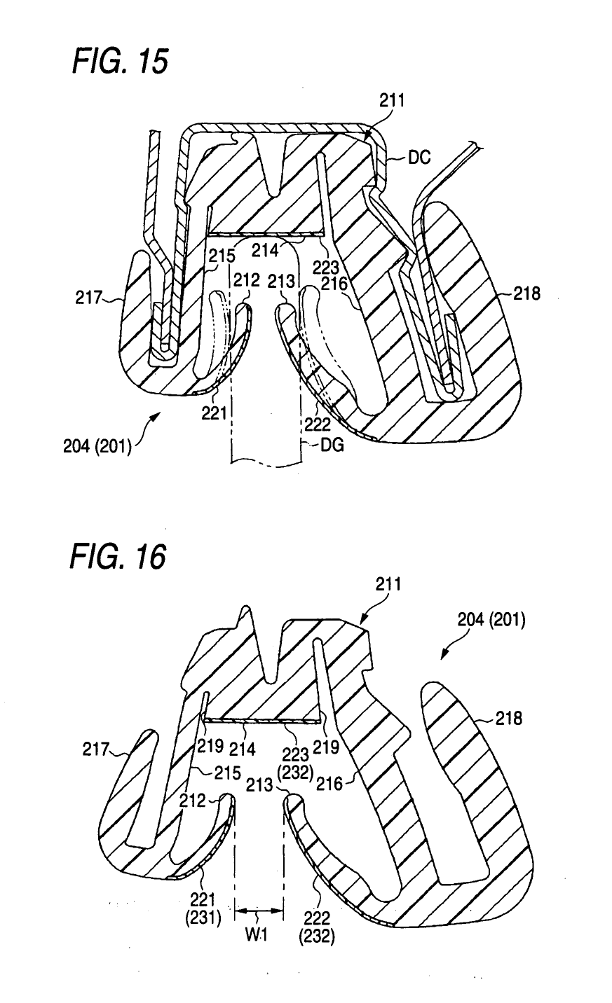

Hereinafter, a third embodiment will be described with reference to the drawings. FIG. 15 is a sectional view along a line L-L of FIG. 1 showing a rear vertical side portion of a glass run. FIG. 16 is a sectional view showing a glass run not mounted to a channel portion serving as a mounting portion.

Similarly to the first embodiment, as shown in FIG. 1, in an automotive door 61 (front door in the figure), provided is a glass run 201 that guides raising and lowering of a door glass DG and seals between an outer periphery of the door glass DG and a door frame 62 when the door glass DG is raised to shut a window portion. In greater detail, the glass run 201 includes an upper side portion 202 which is a part corresponding to an upper edge portion of the door glass DG, a front vertical side portion 3 which is a part extending downward from a front end portion of the upper side portion 202 and corresponding to a front edge portion of the door glass DG, and a rear vertical side portion 204 which is a part extending downward from a rear end portion of the upper side portion 202 and corresponding to a rear edge portion of the door glass DG. And, said glass run 201 is mounted to the inside of a channel portion DC formed along an inner periphery of the door frame 62 and a sash portion DS provided in a door panel 63 in a manner extending front and rear vertical side portions of the channel portion DC downward.

As shown in FIG. 15, the rear vertical side portion 204 of the glass run 201 includes a main body portion 211, an exterior seal lip 212, and an interior seal lip 213. The main body portion 211 includes a base bottom portion 214 to be fitted into the channel portion DC and an exterior sidewall portion 215 and an interior sidewall portion 216 extended from said base bottom portion 214 and forms as a whole an approximately U-shape in section. The exterior seal lip 212 extends from almost the front end of the exterior sidewall portion 215 toward an inner peripheral side of the main body portion 211, and the interior seal lip 213 extends from almost the front end of the interior sidewall portion 216 toward an inner peripheral side of the main body portion 211. And, in a shut state of the door glass DG, the exterior seal lip 212 is made to press-contact with an outer surface of the door glass DG, and the interior seal lip 213 is made to press-contact with an inner surface of the door glass DG. Thereby, exterior and interior sides of the door glass DG are sealed, respectively. In addition, an exterior molding lip 217 extending outward (toward the exterior side of the vehicle) from the exterior sidewall portion 215 and an interior molding lip 218 extending outward (toward the interior side of the vehicle) from the interior sidewall portion 216 are provided. In the present embodiment, the main body portion 211, the seal lips 212 and 213, and the molding lips 217 and 218 are made of a dynamically crosslinked olefinic thermoplastic elastomer (TPV).

The exterior seal lip 212 and the interior seal lip 213 according to the present embodiment do not extend straight but extend while gently curving so as to slightly bulge out toward the door glass DG in a state mounted to the channel portion DC. Thereby, an improvement in sealing performance is realized. Moreover, at a boundary between the base bottom portion 214 and the exterior sidewall portion 215 and a boundary between the base bottom portion 214 and the interior sidewall portion 216, formed are slit portions 219 concaved toward the outer periphery of the main body portion 211. Due to the existence of said slit portions 219, when mounting the glass run 1 to the channel portion DC, both sidewall portions 215 and 216 can be easily contracted, so that an improvement in mounting workability can be realized.

Moreover, as shown in FIG. 16, in the present embodiment, in a state before the glass run 201 is mounted to the channel portion DC, an interval W1 between a front end portion of the exterior seal lip 212 and a front end portion of the interior seal lip 213 is set within a range of 1.5 mm to 3.0 mm. On the other hand, the thickness of the door glass DG is approximately 4.0 mm to 5.0 mm. Therefore, when mounting (fitting together) the glass run 201 to the channel portion DC (sash portion DS), a marginal portion of the door glass DG can be reliably sealed by a pair of seal lips 212 and 213 without forcibly narrowing the interval between the exterior seal lip 212 and the interior seal lip 213.

In addition, the upper side portion 202 and the front vertical side portion 203 also include the main body portion 211 and the pair of seal lips 212 and 213. However, of the glass run 201, with regard to a part disposed in the door panel 63 below a belt line and not appearing on the exterior (the front vertical portion 203 and a lower portion of the rear vertical side portion 204 in the present example), the exterior molding lip 217 and the interior molding lip 218 are omitted, and therein the size is reduced together with the sash portion DS to which this part is attached. Moreover, the exterior seal lip 212 is formed shorter (smaller) than the interior seal lip 213. Thereby, the door glass DG is urged to the exterior side of the vehicle, so that a flush surface can be attained. In the present embodiment, for the glass run 201, an entire longitudinal area having a sectional shape having the main body portion 211 and the interior and exterior seal lips 212 and 213 and provided with the upper side portion 202, the front vertical side portion 203, and the rear vertical side portion 204 is integrally formed by molding.

Meanwhile, in the present embodiment, an exterior sliding layer 221 and an interior sliding layer 222 are formed on door glass sliding surfaces of the exterior seal lip 212 and the interior seal lip 213, and a base-portion-side sliding layer 223 is formed on an inner surface of the base bottom portion 214. Thereby, slidability of the door glass DG is improved at the respective portions. Also, although details will be described later, each of the sliding layers 221, 222, and 223 is formed by a polyethylene sheet serving as a sliding member (PE) being buried so as to be exposed on the surface. Moreover, on the door glass sliding surfaces of the exterior seal lip 212 and the interior seal lip 213, a part formed with the sliding layer 221, 222 and a part excluding the same are flush without a step therebetween. Further, the base-portion-side sliding layer 223 is formed across the entire area of the base bottom portion 214 (from the slit portion 219 on the exterior side of the vehicle to the slit portion 219 on the interior side of the vehicle) in the width direction of the vehicle.

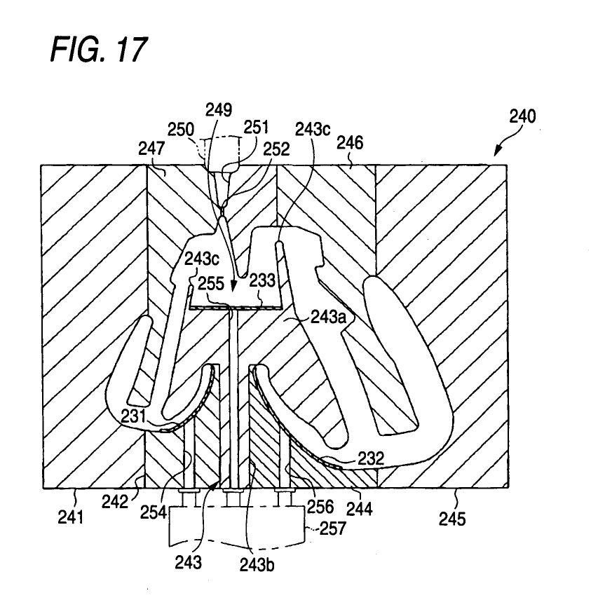

Next, a molding device 240 shown in FIG. 17 will be described as an example of a molding device to mold the glass run 201 according to the present embodiment. Also, FIG. 17 shows a section of the molding device 240 in a mold clamping state after PE sheets 231, 232, and 233 that are to form the sliding layers 221, 222, and 223 are set in a cavity 249. is As shown in FIG. 17, the molding device 240 includes a first mold 241, a second mold 242, a third mold 243, a fourth mold 244, a fifth mold 245, a sixth mold 246, and a seventh mold 247. On these molds 241 to 247, formed are molding surfaces corresponding to an outer shape of the glass run 201, respectively, and these molding surfaces form the cavity 249 to mold the glass run 201.

Moreover, the third mold 243 is composed of a core mold 243a that molds respective inner peripheral surfaces of the main body portion 211, the exterior seal lip 212, and the interior seal lip 213 and a holding plate 243b that holds said core mold 243a. Further, in the third mold 243 (core mold 243a), provided at both side portions of the molding surface to mold the inner surface of the base bottom portion 214 are a pair of molding projections 243c protruded toward the inside of the cavity 249. By said molding projections 243c, the slit portions 219 are molded at the boundary between the base bottom portion 214 and the exterior sidewall portion 215 and the boundary between the base bottom portion 214 and the interior sidewall portion 216. Moreover, in the present embodiment, the thickness of the holding plate 243b of the third mold 243 is set to be 1.5 mm to 3.0 mm.

Further, a first suction hole 254 is formed in the molding surface, of the second mold 242, to mold the door glass sliding surface of the exterior seal lip 212, a second suction hole 255 is formed in the molding surface, of the third mold 243, to mold the inner surface of the base bottom portion 214, and a third suction hole 256 is formed in the molding surface, of the fourth mold 244, to mold the door glass sliding surface of the interior seal lip 213. In the present embodiment, a suction device 257 provided side by side with the molding device 240 is formed so as to be able to suck air in the cavity 249 via the suction holes 254, 255, and 256.

Next, a manufacturing method of the glass run 201 will be described. First, in a mold opening state of the molding device 240, the PE sheet 231 is set on the molding surface, of the second mold 242, to mold the door glass sliding surface of the exterior seal lip 212, the PE sheet 232 is set on the molding surface, of the fourth mold 244, to mold the door glass sliding surface of the interior seal lip 213, and the PE sheet 233 is set on the molding surface, of the third mold 243, to mold the inner surface of the base bottom portion 214. Particularly, the PE sheet 233 provided in a manner corresponding to the inner surface of the base bottom portion 214 is formed with its horizontal width almost equal to the distance between the pair of molding projections 243c provided in the third mold 243 (core mold 243a). Thereby, the PE sheet 233 is, when being placed on the molding surface, disposed between the pair of molding projections 243c, and both side portions of the PE sheet 233 are brought into a condition abutted against the molding projections 243c, respectively. In other words, the PE sheet 233 is accurately positioned.

Moreover, when the PE sheets 231, 232, and 233 are placed on the respective molding surfaces, said PE sheets 231, 232, and 233 are sucked by the suction device 257 via the suction holes 254, 256, and 255. Thereby, the PE sheets 231, 232, and 233 are closely fitted to the corresponding respective molding surfaces, and this state is maintained.

Then, mold clamping is performed with the PE sheets 231, 232, and 233 remaining in a state sucked by the suction device 257, and a TPV in a plasticized condition is injected by an injection device 250 into the cavity 249 via a sprue 251 and a gate 252 formed in the seventh mold 247, and filled. After completion of solidification, mold opening is performed to remove the molded glass run 201 from the molding device 240. Thereby, an entire longitudinal area of the glass run 201 having a sectional shape having the main body portion 211, the seal lips 212 and 213, the sliding layers 221, 222, and 223, and the like and provided with the upper side portion 202, the front vertical side portion 203, and the rear vertical side portion 204 is obtained integrally as in the above.

As has been described in detail above, in the present embodiment, the entire longitudinal area of the glass run 201 is formed by molding. Therefore, unlike a glass run formed, for example, by connecting a plurality of molded bodies including extruded bodies in the longitudinal direction, such a situation that a connection line connecting the adjacent molded bodies together appears on the exterior can be avoided. Moreover, such a situation that a difference in color and luster partially occurs in the longitudinal direction (circumferential direction) of the glass run 201 can be avoided. As a result, an improvement in external appearance quality can be realized. Furthermore, such a possibility that an unnecessary step is formed in the longitudinal direction of the glass run 201 can be avoided, so that an improvement in sealing performance can be realized.

Moreover, since a molded body is higher in the degree of freedom of product design than an extruded body, even when, for example, a glass run is differentiated in the sectional shape at a specific part, this can be easily molded by molding. In the present embodiment, although a part of the glass run 201 below the belt line (lower portion of the rear vertical side portion 204 and the front vertical side portion 203) has been formed in a shape where the exterior molding lip 217 and the interior molding lip 218 are omitted, this is formed, in molding, simultaneously with other parts, without performing a separate operation such as cutting the exterior molding lip 217 and the interior molding lip 218. Therefore, such a situation that a separate operation (post processing) is required for differentiating the sectional shape at a specific part can be avoided, so that an improvement in productivity can be realized.

Moreover, in comparison with, for example, when the glass run 201 is formed by assembling a plurality of molded bodies, an improvement in manufacturing workability is realized since no assembling operation is required, and the cost can be reduced since one molding device is sufficient. Further, a possibility such that a misalignment and detachment of a plurality of molded bodies to compose a glass run causes a decline in sealing performance, a deterioration in a mounting state to a mounting portion, and a decline in mounting workability can be prevented.

Further, the thickness of the holding plate 243b of the third mold 243 is set to 1.5 mm or more and 3.0 mm or less. Providing the thickness of the holding plate 243b as 1.5 mm or more allows securing the strength of the third mold 243 (holding plate 243b). Moreover, providing the thickness of the holding plate 243b as 3.0 mm or less allows providing the interval W1 between the interior seal lip 213 and the exterior seal lip 212 at the time of molding as 3.0 mm or less. This allows saving forcibly narrowing the interval between the seal lips 212 and 213 thereafter, so that sealing performance to the marginal portions of the inner and outer surfaces of the door glass DG with a thickness of approximately 4.0 mm to 5.0 mm can be secured.

Moreover, the main body portion 211 and the seal lips 212 and 213 are made of a TPV. For example, when the main body portion 211 and the seal lips 212 and 213 are made of a rubber material such as EPDM, the EPDM or the like has a relatively high viscosity, and when intending to fill this in every corner of the cavity 249 of the molding device 240, it becomes necessary to provide the injection pressure as a high pressure or it becomes necessary to increase the number of gates for injection. When the former construction is adopted, the EPDM or the like may intrude into a butting portion of a plurality of molds that form the cavity 249, and this may lead to burring. On the other hand, when the latter construction is adopted, this may cause complication of the mold structure. In contrast thereto, according to the present embodiment, since the main body portion 211 and the seal lips 212 and 213 are made of a TPV which is lower in viscosity than EPDM or the like, burring can be prevented and complication of the mold structure can be prevented to suppress an increase in the manufacturing cost. Moreover, as a result of forming the main body portion 211 and the seal lips 212 and 213 of a TPV, a vulcanization step is not required, so that an improvement in productivity can be realized.

Moreover, according to the present embodiment, in molding of the glass run 201, the sliding layers 221, 222, and 223 are simultaneously formed. In other words, by insert-molding the PE sheets 231, 232, and 233 at the time of molding, the glass run 201 formed with the sliding layers 221, 222, and 223 is obtained. Therefore, an operation, such as adhering a tape material or applying a sliding agent to the door glass sliding surfaces of the seal lips 212 and 213 and the inner surface of the base bottom portion 214, after molding, for forming the sliding layers 221, 222, and 223 can be omitted, so that an improvement in manufacturing workability can be realized.

In addition, since the TPV to form the glass run 201 and the PE sheets 231, 232, and 233 to form the sliding layers 221, 222, and 223 have compatibility, both of these can be strongly joined together even without separately using an adhesive and the like.

Moreover, in molding of the glass run 201, the PE sheets 231, 232, and 233 are set in the cavity 249 in order to form the sliding layers 221, 222, and 223, while according to the present embodiment, the PE sheets 231, 232, and 233 set in the cavity 249 are sucked by the suction device 257 via the suction holes 254, 256, and 255. Thereby, the PE sheets 231, 232, and 233 are brought into a condition closely fitted to the corresponding respective molding surfaces, and a misalignment and floating-up of the PE sheets 231, 232, and 233 are controlled. And, in this condition, a TPV in a plasticized state, which is a molding material, is injected into the cavity 249. Therefore, a possibility such that, when a TPV is injected and filled into the cavity 249, the FE sheets 231, 232, and 233 are misaligned or the TPV intrudes between the PE sheets 231, 232, and 233 and the molding surfaces corresponding thereto, so that the PE sheets 231, 232, and 233 are no longer exposed on the surface of the glass run 201 can be prevented. Accordingly, the PE sheets 231, 232, and 233 can be reliably exposed on the surface at expected positions, so that the sliding layers 221, 222, and 223 can be more accurately formed.

Further, the PFE sheet 233 provided in a manner corresponding to the inner surface of the base bottom portion 214 is, when being placed on the molding surface forming the cavity 249, disposed between the pair of molding projections 243c provided in the third mold 243 (core mold 243a), and both side portions of the PE sheet 233 are brought into a condition abutted against the molding projections 243c, respectively. This allows not only accurately positioning the PE sheet 233 when placing on said molding surface, but, when filling a TPV into the cavity 249, also more reliably preventing misalignment of the PE sheet 233.

Moreover, in such a case, for example, where in order to form sliding layers on the door glass sliding surfaces of the exterior seal lip 212 and the interior seal lip 213 formed in a curved condition, the PE sheets 231 and 232 are adhered after molding, such an operation may become relatively difficult, which may cause a decline in workability, a degradation in quality, and the like. In this respect, according to the present embodiment, for the door glass sliding surfaces of the exterior seal lip 212 and the interior seal lip 213, the sliding layers 221 and 222 can be formed simultaneously with molding as well as at accurate positions, and thus these inconveniences can be eliminated. Further, such a situation that, on the door glass sliding surface of the seal lips 212, 213, a step is formed at a boundary between the sliding layer 221, 222 and a common part made of a TPV can be avoided.

In addition, when, for example, a glass run is separated as two exterior and interior molded bodies at the base bottom portion and the glass run is formed by assembling both molded bodies, sliding layers (base-portion-side sliding layers) corresponding to the inner surface of the base bottom portion are formed separately for the two molded bodies. In this case, required is an operation to form base-portion-side sliding layers, in molding of the two molded bodies, respectively, and this may cause a decline in manufacturing workability, complication of a mold structure, and the like. Further, it becomes necessary to form, for each of the molding devices to mold the respective molded bodies, respectively, a mechanism (such as providing a suction hole) for preventing misalignment of a PE sheet placed to form a base-portion-side sliding layer, respectively. In this respect, according to the present embodiment, for the glass run 201, by molding, integrally formed is an entire longitudinal area having a sectional shape having the main body portion 211 and the interior and exterior seal lips 212 and 213. More specifically, the base-portion-side sliding layer 223 corresponding to the inner surface of the base bottom portion 214 is formed in a single molded body. Accordingly, since one time of operation for forming the base-portion-side sliding layer 223 is sufficient, the above-mentioned inconveniences can be prevented.

Also, without being limited to the contents of description of the above embodiment, the present invention may be carried out, for example, as follows. As a matter of course, other applications and modifications not exemplified in the following can also be made.

(a) In the above embodiment, although the suction device 257 is used in order to closely fit the PE sheets 231, 232, and 233 (sliding members) to the molding surfaces and maintain the closely-fitted condition, the present invention is not particularly limited to such a construction, and it suffices with a construction not to cause a misalignment of the sliding members when injecting and filling a TPV into the cavity 249. For example, a misalignment of the sliding members may be prevented by use of static electricity. In this case, since a holding force can be uniformly exerted to the entire surface. of the sliding member, such a possibility that the sliding member partially floats up from the molding surface can be prevented.

Alternatively, for the molds 242, 244, and 243, control portions that catch end portions of the PE sheets 231, 232, and 233 may be provided. In this case, even without providing a suction device and the like, a deviation movement and floating-up of the PE sheets 231, 232, and 233 can be controlled by the control portions. As a result, misalignment of the sliding members can be prevented, while an increase in the cost and the like is suppressed. Further, it is also possible to combine said control portions with such a construction as sucking sliding members in the above embodiment, and in that case, floating-up of the end portions of the sliding members can be more reliably prevented. Also, the control portions may be partially provided in the longitudinal direction of the cavity 249. In other words, although predetermined concave portions are to be formed in the glass run 201 due to provision of the control portions in the molds 242, 243, and 244, such a situation that a part, of the glass run 201, formed with the concave portions is easily deformed or durability declines as a result of partially providing the control portions in the longitudinal direction can be prevented.

Although, in FIG. 17, all suction holes 254, 255, and 256 are connected to the single suction member 257, the respective suction holes 254, 255, and 257 may be individually connected to corresponding suction device, respectively. Moreover, in FIG. 17, although the holding plate 243b of the third mold 243 is formed with a slightly smaller thickness than the interval between a molding surface to mold the exterior seal lip 212 and a molding surface to mold the interior seal lip 213 (that is, the interval between the exterior seal lip 212 and the interior seal lip 213 at the time of molding), the holding plate 243b may be formed with the same thickness as the interval between the exterior seal lip 212 and the interior seal lip 213 at the time of molding.

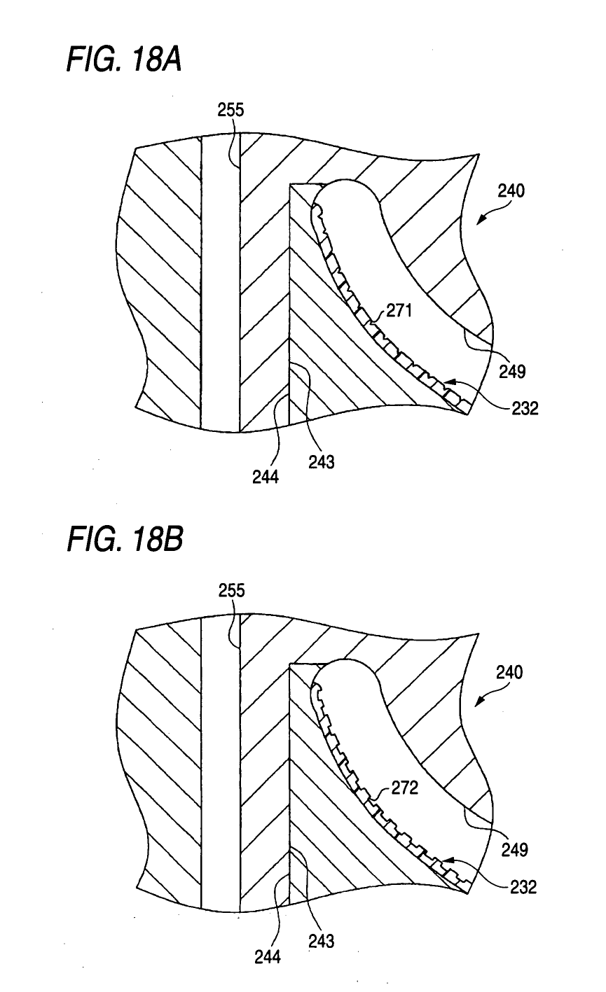

(b) Although not particularly mentioned in the above embodiment, for example, as shown in FIG. 18A and 18B, groove portions 271 having an approximately V shape in section or concave portions 272 to form a thin-wall portion may be provided in a plurality of rows on one surface of the PE sheet 232 to form the interior sliding layer for the door glass sliding surface of the interior seal lip 213, which is a curved surface. In this case, the PE sheet 232 can be smoothly deformed along the molding surface of the fourth mold 244. Accordingly, the PE sheet 232 can be closely fitted to the molding surface relatively easily and more reliably, so that an improvement in manufacturing workability and an improvement in product quality can be realized. Also, the same operations and effects can also be provided by forming groove portions and concave portions on the PE sheet 231 to form the exterior sliding layer 221 for the exterior seal lip 212.

Moreover, as shown in FIG. 18A and 18B since the PE sheet 232 is set so that the surface formed with the groove portions 271 or the concave portions 272 faces the inside of the cavity 249, the surface, of the PE sheet 232, on the side to be buried in the interior seal lip 213 is increased in the surface area, so that the PE sheet 232 can be more strongly joined with the interior seal lip 213. Also, with regard to the PE sheet 231 to form the exterior sliding layer 221 and the PE sheet 233 to form the base-portion-side sliding layer 223, the same operations and effects can be provided by forming the groove portions 271 or the concave portions 272 and placing the surface formed with same so as to face the inside of the cavity 249 in molding.

(c) In the above embodiment, although the sliding layers 221, 222, and 223 are formed for the door glass sliding surfaces of the seal lips 212 and 213 and the inner surface of the base bottom portion 214, respectively, the present invention is not particularly limited to such a construction, and it suffices that any one of the sliding layers 221, 222, and 223 is formed. For example, with regard to the upper side portion 202 of the glass run 201, the base-portion-side sliding layer 223 may be omitted.

Moreover, in the longitudinal direction of the glass run 201, there may even be a section where none of the sliding layers 221, 222, and 223 are formed, and for example, the sliding layers 221, 222, and 223 at corners of the glass run 201 may be omitted. Also, even when the sliding layers 221, 222, and 223 are partially and intermittently formed in the longitudinal direction of the glass run 201, since the glass run 201 is formed of a molded body as in the above, these can be formed relatively easily and correctly.

(d) In the above embodiment, although the main body portion 211 and the interior and exterior seal lips 212 and 213 are made of a TPV, these may be made of, for example, a non-crosslinked olefinic thermoplastic elastomer (TPO). Further, although the sliding members (sliding layers 221, 222, and 223) are made of polyethylene (PE sheets 231, 232, and 233), these may be made of another material such as polypropylene. Also, the main body portion 211 and the interior and exterior seal lips 212 and 213 and the sliding members are both made of olefinic elastomers, can be strongly bonded (thermally bonded).

Moreover, in the above embodiment, although the glass run 201 of the front door has been particularly described in detail, with regard to a glass run and the like of the rear door as well, an entire longitudinal area may be integrally formed by molding, and the sliding layers 221, 222, and 223 maybe formed simultaneously with the main body portion 211 and the seal lips 212 and 213. Further, the present invention can also be applied to a glass run having a sectional shape without the molding lips 217 and 218, for example.

(e) A buffering projection that is protruded upward from the base bottom portion 214 of the upper side portion 202 and buffers a shock when the door glass DC is shut may be provided. Moreover, a deviation preventing protrusion that is protruded upward from the base bottom portion 214 of the upper side portion 202 and controls a deviation movement of the glass run 201 in the longitudinal direction by being latched with a hole portion or a concave portion formed in the channel portion DC in a state where the glass run 201 is mounted to the channel portion DC may be provided. Further, the upper side portion 202 may be provided with a glass guide protruded downward from a boundary between the exterior sidewall portion 215 and the exterior seal lip 212 and for guiding, when the rising door glass DC is displaced to the exterior side of the vehicle, the upper edge portion of said door glass DG to the inside of the main body portion 211. Thus, even when the buffering projection, the deviation preventing protrusion, the glass guide, and the like are provided, these can be integrally formed with other parts at the time of molding. Therefore, such a situation that a post processing is required due to provision of the buffering projection, the deviation preventing protrusion, the glass guide, and the like, thus causing a decline in manufacturing workability can be avoided. Also, the deviation preventing protrusion may be insert-molded in molding of the glass run 201.

(f) Moreover, although not particularly mentioned in the above embodiment, at the time of molding, the upper side portion 202, the front vertical side portion 203, and the rear vertical side portion 204 maybe formed in a curved condition in accordance with a curvature of the channel portion DC. More specifically, for the door 61, in design, an upper part of the door 61 from the belt line can be formed in a curved condition so as to tilt toward the interior side of the vehicle, and accordingly, not only the door glass DG but also the channel portion DC are formed in a curved condition. By thus forming the upper side portion 202, the front vertical side portion 203, and the rear vertical side portion 204 of the glass run 201 in a curved condition in accordance with a curvature of the channel portion DC, in comparison with when, for example, a linearly formed glass run is made to follow the channel portion DC extending while curving and attached thereto, stabilization of a mounting state, an improvement in external appearance quality, and an improvement in sealing performance can be realized. Moreover, as a result of the glass run 201 being formed in a curved condition, an operation to adhere sliding members to the base bottom portion 214 and the interior and exterior seal lips 212 and 213 may become relatively difficult, which may cause a decline in workability, a degradation in quality, and the like. In this respect, according to the above embodiment, since the sliding layers can be formed simultaneously with molding as well as at accurate positions, these inconveniences can be eliminated.

What is claimed is:

1. A glass run comprising:
a main body portion attached to a mounting portion provided along an inner periphery of a door frame of a vehicle and having an approximately U-shape in section, the main body portion including a base bottom portion, an interior sidewall portion and an exterior sidewall portion extending from the base bottom portion; and
an interior seal lip and an exterior seal lip extending from almost front ends of the interior sidewall portion and the exterior sidewall portion to an inside of the main body portion,
wherein an entire longitudinal area is integrally formed by molding so as to be provided with an upper side portion corresponding to an upper edge portion of a door glass and a front vertical side portion and a rear vertical side portion corresponding to a front edge portion and a rear edge-portion. of the door glass, respectively,
an interval between the interior seal lip and the exterior seal lip at the time of molding is set to 1.5 mm or more and 3.0 mm or less, and
the main body portion and the interior and exterior seal lips are made of an olefinic thermoplastic elastomer.

2. The glass run according to claim 1, wherein, in the upper side portion, a projection that is protruded upward from the base bottom portion is partially provided.

3. The glass run according to claim 1, wherein, a glass guide that is protruded downward from a boundary between the exterior sidewall portion and the external seal lip is provided in the upper side portion.

4. The glass run according to claim 1, wherein at least the front vertical side portion and the rear vertical side portion are formed in a curved condition in accordance with a curvature of the mounting portion.

5. The glass run according to claim 1, further comprising a function member provided with a functioning portion disposed inside the main body portion and an engaging portion to be engaged with an engaged portion provided on the base bottom portion.

6. The glass run according to claim 5, wherein the engaged portion is provided partially or intermittently in a longitudinal direction of the glass run.

7. The glass run according to claim 5, wherein the functioning portion includes a sub-lip that is contactable with a surface opposite to a door glass sliding-contact surface of the interior seal lip.

8. The glass run according to claim 5, wherein at least the functioning portion of the function member provided in the upper side portion is abutted against an inner surface of the base bottom portion to form an inner surface of the main body portion, and is formed of foam at, at least, a part that contacts the door glass.

9. The glass run according to claim 5, wherein at least the functioning portion of the function member provided in the upper side portion is abutted against an inner surface of the base bottom portion to form an inner surface of the main body portion, and exhibits a hollow shape.

10. The glass run according to claim 5, wherein at least the functioning portion of the function member provided in the front vertical side portion and the rear vertical side portion is abutted against an inner surface of the base bottom portion to form an inner surface of the main body portion, and is made of a material harder than that of the main body portion.

11. The glass run according to claim 5, wherein the functioning portion extends, in a state before the function member is attached, laterally in a width direction from a connecting portion with the engaging portion or a vicinity thereof, in a manner tilting toward a protruding direction of the engaging portion.

12. A manufacturing method of a glass run comprising a main body portion attached to a mounting portion provided along an inner periphery of a door frame of a vehicle and having an approximately U-shape in section, the main body including a base bottom portion and an interior sidewall portion and an exterior sidewall portion extending from the base bottom portion, and an interior seal lip and an exterior seal lip extending from almost front ends of the interior sidewall portion and the exterior sidewall portion to an inside of the main body portion, wherein the manufacturing method comprising steps:
forming a cavity by a molding device including a plurality of molds,
injecting and filling a molding material into the cavity, and
integrally molding an entire longitudinal area so as to have a sectional shape having the main body portion and the interior and exterior seal lips and as to be provided with an upper side portion corresponding to an upper edge portion of a door glass and a front vertical side portion and a rear vertical side portion corresponding to a front edge portion and a rear edge portion of the door glass, respectively,
wherein an interval between the interior seal lip and the exterior seal lip at the time of molding is set to 1.5 mm or more and 3.0 mm or less, and
the molding material is an olefinic thermoplastic elastomer.

13. The manufacturing method of a glass run according to claim 12, wherein a sliding member made of a material harder than that of the main body portion is placed on at least a part of molding surfaces forming the cavity that are to mold a door glass sliding surface of the interior seal lip and a door glass sliding surface of the exterior seal lip, and
the molding material is injected into the cavity on which the sliding member is placed so that a sliding layer is formed on the door glass sliding surface of at least either one of the interior seal lip and the exterior seal lip.

14. The manufacturing method of a glass run according to claim 12, wherein a sliding member made of a material harder than that of the main body portion is placed on a part of molding surfaces forming the cavity that are to mold an inner surface of the base bottom portion, and
the molding material is injected into the cavity on which the sliding member is placed, so that a sliding layer is formed on the inner surface of the base bottom portion.

15. The manufacturing method of a glass run according to claim 12, wherein sliding members made of a material harder than that of the main body portion are placed on parts of molding surfaces forming the cavity that are to mold an inner surface of the base bottom portion, a door glass sliding surface of the interior seal lip, and a door glass sliding surface of the exterior seal lip, and
the molding material is injected into the cavity on which the sliding members are placed so that sliding layers are formed on the inner surface of the base bottom portion, the door glass sliding surface of the interior seal lip, and the door glass sliding surface of the exterior seal lip.

16. The manufacturing method of a glass run according to claim 12, wherein at least the door glass sliding surfaces of the interior seal lip and the exterior seal lip are formed in a curved condition.

17. The manufacturing method of a glass run according to claim 13, wherein a pair of slit portions concaved toward an outer periphery of the main body portion simultaneously with the main body portion by molding are formed at a boundary between the base bottom portion and the interior sidewall portion and a boundary between the base bottom portion and the exterior sidewall portion, and
the sliding member provided in a manner corresponding to the inner surface of the base bottom portion is disposed between a pair of molding projections formed on the mold to mold the pair of slit portions, and both side portions of the sliding member are brought in a condition abutted against the molding projections, respectively.

18. The manufacturing method of a glass run according to claim 17, further comprising a positioning step of holding the sliding member in a condition closely fitted to a corresponding molding surface of the cavity,
wherein the molding material is filled in a condition where the sliding member is held.

19. The manufacturing method of a glass run according to claim 12, wherein the sliding member is formed in a sheet form, and on one surface thereof, groove portions or concave portions are formed in a plurality of rows.

20. The glass run according to claim 1, wherein a sliding member made of a material harder than that of the main body portion is provided by insert molding at the time of molding so that the glass run includes a sliding layer formed on at least any one of an inner surface of the base bottom portion, a door glass sliding surface of the interior seal lip, and a door glass sliding surface of the exterior seal lip by the sliding member being exposed.
